(19) United States
(12) Patent Application Publication
(10) Pub. No.: US 2026/0214289 A1
(43) Pub. Date: Jul. 23, 2026

(54) INFORMATION PROCESSING DEVICE AND INFORMATION PROCESSING METHOD

(71) Applicant: Sony Group Corporation, Tokyo (JP)

(72) Inventors: Yuichi Morioka, Tokyo (JP); Yasufumi Hayashida, Tokyo (JP)

(73) Assignee: Sony Group Corporation, Tokyo (JP)

(21) Appl. No.: 19/143,198

(22) PCT Filed: Dec. 20, 2023
(86) PCT No.: PCT/JP2023/045702

§ 371 Date: Jun. 25, 2025

(30) Foreign Application Priority Data
Jan. 6, 2023 (JP) 2023-000903

(51) Int. Cl. H04N 21/414; H04N 21/2187; H04N 21/81

(52) U.S. Cl. CPC H04N 21/41422; H04N 21/2187; H04N 21/8133

(57) ABSTRACT

To suppress deterioration in quality of a content viewed in a moving body. An information processing device includes: an information acquisition unit that selects, on the basis of a movement state of a moving body, first video information indicating a video of a content viewed by a user in the moving body, or variable information that is information varying according to the content, and receives the selected first video information or variable information from a server group including one or more servers; a video generation unit that generates second video information indicating a video of the content, on the basis of fixed information that is information fixed in the content and acquired in advance, and the variable information; and an output control unit that controls output of the first video information and the second video information to a display unit. The present technology can be applied to, for example, a vehicle.

### TECHNICAL FIELD

The present technology relates to an information processing device and an information processing method, and more particularly, to an information processing device and an information processing method suitable for use in a case where a content is viewed in a moving body.

### Cross Reference To Related Applications

This application claims the benefit of Japanese Priority Patent Application JP 2023-000903 filed on Jan. 6, 2023, the entire contents of which are incorporated herein by reference.

### BACKGROUND ART

In an automated vehicle to which an automated driving technology is applied, since passengers can spend time as they wish while in transit, for example, it is assumed that the passengers enjoy an entertainment content such as a concert or a movie in the vehicle (see, for example, PTL 1).

Furthermore, in a case where an entertainment content of an event such as a concert can be viewed in real time in a vehicle, for example, interactivity between a performer and an audience and between audiences is secured, and a satisfaction level of users for the content is improved due to empathy.

Meanwhile, the size of data of an entertainment content is very large. Therefore, for example, in order to view a video of an event such as a concert in real time in a vehicle, it is necessary to secure a stable wireless communication line with a high transmission speed between a server that distributes the content and the vehicle.

### Citation List

### Patent Literature

PTL 1: JP 2021-170694 A

### SUMMARY OF INVENTION

### Technical Problem

However, the quality of the wireless communication line between the server and the vehicle is not necessarily stable. For example, in a case where the vehicle is traveling in an urban area, since there are many vehicles, passersby, and the like that use the wireless communication line, a communication band that can be used for transmission of the entertainment content is narrowed. For example, in a case where the vehicle executes automated driving, it is necessary to transmit and receive a large amount of data such as map information and sensor data to and from the server or the like according to a state around the vehicle or the like, and the communication band that can be used for transmission of the entertainment content is narrowed. Therefore, the quality of the content viewed in the vehicle may be deteriorated.

The present technology has been made in view of such a situation, and is intended to suppress deterioration in quality of a content viewed in a moving body such as a vehicle.

### Solution to Problem

An information processing device according to a first aspect of the present technology includes: an information acquisition unit that selects, on the basis of a movement state of a moving body, first video information indicating a video of a content viewed by a user in the moving body, or variable information that is information varying according to the content, and receives the selected first video information or variable information from a server group including one or more servers; a video generation unit that generates second video information indicating a video of the content, on the basis of fixed information that is information fixed in the content and acquired in advance, and the variable information; and an output control unit that controls output of the first video information and the second video information to a display unit.

An information processing method according to a second aspect of the present technology executed by an information processing device includes: selecting, on the basis of a movement state of a moving body, first video information indicating a video of a content viewed by a user in the moving body, or variable information that is information varying according to the content, and receiving the selected first video information or variable information from a server group including one or more servers; outputting the first video information to a display unit in a case where the first video information is received; and generating second video information indicating a video of the content on the basis of fixed information that is information fixed in the content and acquired in advance, and the variable information, and outputting the second video information to the display unit in a case where the variable information is received.

In the first aspect of the present technology, the first video information indicating the video of the content viewed by the user in the moving body or the variable information that is information varying according to the content is selected on the basis of the movement state of the moving body and is received by from the server group including one or more servers, the second video information indicating the video of the content is generated on the basis of the fixed information that is information fixed in the content and acquired in advance, and the variable information, and the output of the first video information and the second video information to the display unit is controlled.

In the second aspect of the present technology, the first video information indicating the video of the content viewed by the user in the moving body or the variable information that is information varying according to the content is selected on the basis of the movement state of the moving body and is received from the server group including one or more servers, the first video information is output to the display unit in a case where the first video information is received, and the second video information indicating the video of the content is generated on the basis of fixed information that is information fixed in the content and acquired in advance, and the variable information, and the second video information is output to the display unit in a case where the variable information is received.

### BRIEF DESCRIPTION OF DRAWINGS

FIG. 1 is a block diagram illustrating a configuration example of a vehicle control system.

FIG. 2 is a diagram illustrating an example of a sensing area.

FIG. 3 is a diagram for describing a background of the present technology.

FIG. 4 is a diagram for describing the background of the present technology.

FIG. 5 is a block diagram illustrating a first embodiment of an information processing system to which the present technology is applied.

FIG. 6 is a block diagram illustrating a functional configuration example of a server group.

FIG. 7 is a block diagram illustrating a functional configuration example of a vehicle and an information processing terminal.

FIG. 8 is a flowchart for describing content distribution processing executed by the server group.

FIG. 9 is a flowchart for describing the content distribution processing executed by the server group.

FIG. 10 is a flowchart for describing content reproduction processing executed by the vehicle and the information processing terminal.

FIG. 11 is a flowchart for describing the content reproduction processing executed by the vehicle and the information processing terminal.

FIG. 12 is a sequence diagram illustrating an example of information transmitted between a cloud side and a vehicle side.

FIG. 13 is a block diagram illustrating a second embodiment of an information processing system to which the present technology is applied.

FIG. 14 is a block diagram illustrating a functional configuration example of a content generation unit and a server.

FIG. 15 is a block diagram illustrating a configuration example of a computer.

### DESCRIPTION OF EMBODIMENTS Hereinafter, embodiments for carrying out the present technology will be described. The description will be given in the following order.

1. Configuration Example of Vehicle Control System
2. Background of Present Technology
3. First Embodiment
4. Second Embodiment
5. Modifications
6. Others

### 1. Configuration Example of Vehicle Control System

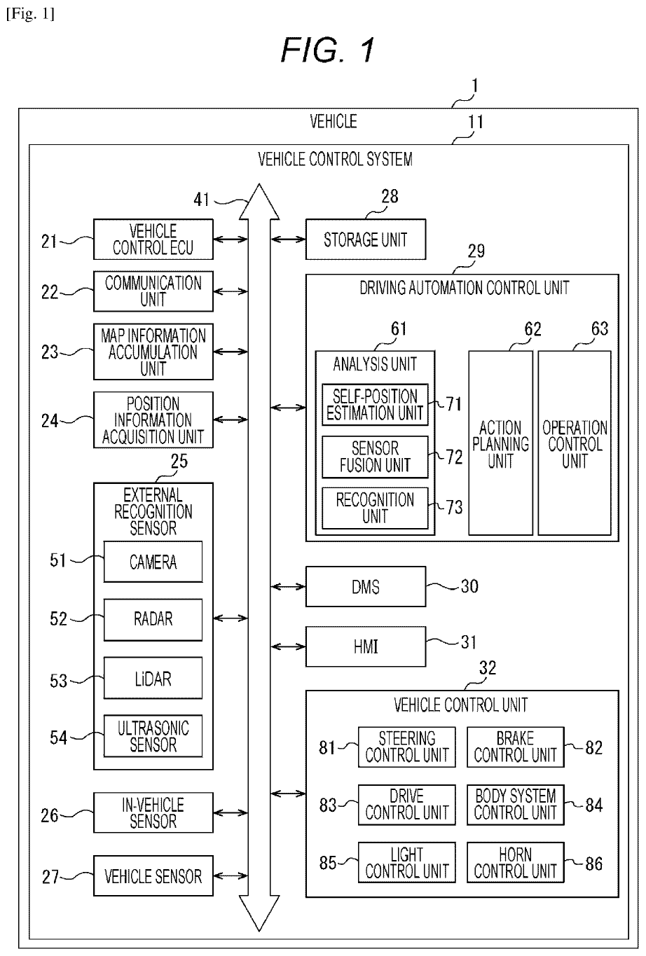

FIG. 1 is a block diagram illustrating a configuration example of a vehicle control system 11 that is an example of a mobile device control system to which the present technology is applied.

The vehicle control system 11 is provided in a vehicle 1 and executes processing related to driving automation of the vehicle 1. The driving automation includes driving automation of Levels 1 to 5, and remote driving and remote assistance of the vehicle 1 by a remote driver.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a driving automation control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the driving automation control unit 29, the DMS 30, the HMI 31, and the vehicle control unit 32 are communicably connected to each other via a communication network 41. The communication network 41 includes, for example, an in-vehicle communication network, a bus, or the like that conforms to a digital bidirectional communication standard such as a controller area network (CAN), a local interconnect network (LIN), a local area network (LAN), FlexRay (registered trademark), or Ethernet (registered trademark). The communication network 41 may be selectively used depending on the type of data to be transmitted. For example, the CAN may be applied to data related to vehicle control, and the Ethernet may be applied to large-volume data. Note that units of the vehicle control system 11 may be directly connected to each other using wireless communication adapted to a relatively short-range communication, such as near field communication (NFC) or Bluetooth (registered trademark) without using the communication network 41.

Note that, hereinafter, in a case where each unit of the vehicle control system 11 performs communication via the communication network 41, the description of the communication network 41 will be omitted. For example, in a case where the vehicle control ECU 21 and the communication unit 22 perform communication via the communication network 41, it will be simply described that the vehicle control ECU 21 and the communication unit 22 perform communication.

The vehicle control ECU 21 includes, for example, various processors such as a central processing unit (CPU) and a micro processing unit (MPU). The vehicle control ECU 21 controls all or some of the functions of the vehicle control system 11.

The communication unit 22 communicates with various devices inside and outside the vehicle, another vehicle, a server, a base station, and the like, and transmits and receives various data. At this time, the communication unit 22 can perform communication using a plurality of communication schemes.

Communication with the outside of the vehicle executable by the communication unit 22 will be schematically described. The communication unit 22 communicates with a server (hereinafter, referred to as an external server) or the like present on an external network via a base station or an access point by, for example, a wireless communication scheme such as fifth generation mobile communication system (5G), long term evolution (LTE), dedicated short range communications (DSRC), or the like.

Examples of the external network with which the communication unit 22 performs communication include the Internet, a cloud network, a company-specific network, and the like. The communication scheme by which the communication unit 22 communicates with the external network is not particularly limited as long as it is a wireless communication scheme allowing digital bidirectional communication at a communication speed equal to or higher than a predetermined speed and over a distance equal to or longer than a predetermined distance.

Furthermore, for example, the communication unit 22 can communicate with a terminal present in the vicinity of a host vehicle using a peer to peer (P2P) technology. The terminal present in the vicinity of the host vehicle is, for example, a terminal attached to a moving body moving at a relatively low speed such as a pedestrian or a bicycle, a terminal fixedly installed in a store or the like, or a machine type communication (MTC) terminal. Moreover, the communication unit 22 can also perform V2X communication. The V2X communication refers to, for example, communication between the host vehicle and another vehicle, such as vehicle to vehicle communication with another vehicle, vehicle to infrastructure communication with a roadside device or the like, vehicle to home communication, and vehicle to pedestrian communication with a terminal or the like carried by a pedestrian.

For example, the communication unit 22 can receive a program for updating software for controlling the operation of the vehicle control system 11 from the outside (Over The Air). The communication unit 22 can further receive map information, traffic information, information regarding the surroundings of the vehicle 1, and the like from the outside. Furthermore, for example, the communication unit 22 can transmit information regarding the vehicle 1, information regarding the surroundings of the vehicle 1, and the like to the outside. Examples of the information regarding the vehicle 1 transmitted to the outside by the communication unit 22 include data indicating the state of the vehicle 1, a recognition result from a recognition unit 73, and the like. Moreover, for example, the communication unit 22 performs communication corresponding to a vehicle emergency call system such as an eCall.

For example, the communication unit 22 receives an electromagnetic wave transmitted by a road traffic information communication system (vehicle information and communication system (VICS) (registered trademark)), such as a radio wave beacon, an optical beacon, or FM multiplex broadcasting.

Communication with the inside of the vehicle executable by the communication unit 22 will be schematically described. The communication unit 22 can communicate with each device in the vehicle using, for example, wireless communication. The communication unit 22 can perform wireless communication with a device in the vehicle by, for example, a communication scheme allowing digital bidirectional communication at a communication speed equal to or higher than a predetermined speed by wireless communication, such as wireless LAN, Bluetooth, NFC, or wireless USB (WUSB).

Communication performed by the communication unit 22 is not limited to wireless communication, and the communication unit 22 can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle by a communication scheme allowing digital bidirectional communication at a communication speed equal to or higher than a predetermined speed by wired communication, such as universal serial bus (USB), high-definition multimedia interface (HDMI) (registered trademark), or mobile high-definition link (MHL).

Here, the device in the vehicle refers to, for example, a device that is not connected to the communication network 41 in the vehicle. As the device in the vehicle, for example, a mobile device or a wearable device carried by a user in the vehicle, such as a driver, an information device brought into the vehicle and temporarily installed, or the like is assumed.

The map information accumulation unit 23 accumulates either or both of a map acquired from the outside and a map created by the vehicle 1. For example, the map information accumulation unit 23 accumulates a three-dimensional high-precision map, a global map that is lower in precision than the high-precision map but covers a wider area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from the external server or the like. The point cloud map is a map including a point cloud (point cloud data). The vector map is, for example, a map in which traffic information such as a lane and a position of a traffic light is associated with the point cloud map and adapted to driving automation.

The point cloud map and the vector map may be provided from, for example, the external server or the like, or may be created by the vehicle 1 as a map for performing matching with a local map to be described later on the basis of a sensing result from a camera 51, a radar 52, a light detection and ranging or laser imaging detection and ranging (LiDAR) 53, or the like, and may be accumulated in the map information accumulation unit 23. Furthermore, in a case where the high-precision map is provided from the external server or the like, for example, map data of several hundred meters square regarding a planned path on which the vehicle 1 travels from now is acquired from the external server or the like in order to reduce the communication traffic.

The position information acquisition unit 24 receives a global navigation satellite system (GNSS) signal from a GNSS satellite, and acquires position information of the vehicle 1. The acquired position information is supplied to the driving automation control unit 29. Note that the position information acquisition unit 24 may acquire the position information using not only a method using the GNSS signal, but also, for example, a beacon.

The external recognition sensor 25 includes various sensors used for recognizing a situation outside the vehicle 1, and supplies sensor data from each sensor to each unit of the vehicle control system 11. The type and number of sensors included in the external recognition sensor 25 may be determined as desired.

For example, the external recognition sensor 25 includes the camera 51, the radar 52, the LiDAR 53, and an ultrasonic sensor 54. It is not limited thereto, and the external recognition sensor 25 may include one or more types of sensors among the camera 51, the radar 52, the LiDAR 53, and the ultrasonic sensor 54. The number of cameras 51, the number of radars 52, the number of LiDARs 53, and the number of ultrasonic sensors 54 are not particularly limited as long as they can be practically installed in the vehicle 1. Furthermore, the external recognition sensor 25 may include sensors of other types, but not limited to sensors of the types described in this example. An example of a sensing area of each sensor included in the external recognition sensor 25 will be described later.

Note that an imaging method of the camera 51 is not particularly limited. For example, as the camera 51, cameras of various imaging methods such as a time of flight (ToF) camera, a stereo camera, a monocular camera, and an infrared camera can be applied as necessary. It is not limited thereto, and the camera 51 may simply acquire a captured image regardless of distance measurement.

Furthermore, for example, the external recognition sensor 25 can include an environment sensor for detecting the environment for the vehicle 1. The environment sensor is a sensor for detecting an environment such as weather, climate, and brightness, and can include various sensors such as a raindrop sensor, a fog sensor, a sunshine sensor, a snow sensor, and an illuminance sensor, for example.

Moreover, for example, the external recognition sensor 25 includes a microphone used for detecting a sound around the vehicle 1, a position of a sound source, and the like.

The in-vehicle sensor 26 includes various sensors for detecting information regarding the inside of the vehicle, and supplies sensor data from each sensor to each unit of the vehicle control system 11. The types and number of various sensors included in the in-vehicle sensor 26 are not particularly limited as long as they can be practically installed in the vehicle 1.

For example, the in-vehicle sensor 26 can include one or more sensors of a camera, a radar, a seating sensor, a steering wheel sensor, a microphone, and a biological sensor. As the camera included in the in-vehicle sensor 26, for example, cameras of various imaging methods capable of measuring a distance, such as a ToF camera, a stereo camera, a monocular camera, and an infrared camera, can be used. It is not limited thereto, and the camera included in the in-vehicle sensor 26 may simply acquire a captured image regardless of distance measurement. The biological sensor included in the in-vehicle sensor 26 is provided in, for example, a seat, a steering wheel, or the like, and detects various types of biological information of the occupant such as the driver.

The vehicle sensor 27 includes various sensors for detecting the state of the vehicle 1, and supplies sensor data from each sensor to each unit of the vehicle control system 11. The types and number of various sensors included in the vehicle sensor 27 are not particularly limited as long as they can be practically installed in the vehicle 1.

For example, the vehicle sensor 27 includes a speed sensor, an acceleration sensor, an angular velocity sensor (gyro sensor), and an inertial measurement unit (IMU) as an integrated sensor including these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of an engine or a motor, an air pressure sensor that detects the air pressure of a tire, a slip rate sensor that detects the slip rate of the tire, and a wheel speed sensor that detects the rotation speed of a wheel. For example, the vehicle sensor 27 includes a battery sensor that detects the state of charge and temperature of a battery, and an impact sensor that detects an external impact.

The storage unit 28 includes at least one of a nonvolatile storage medium or a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The storage unit 28 stores various programs and data used by each unit of the vehicle control system 11. For example, the storage unit 28 includes an event data recorder (EDR) and a data storage system for automated driving (DSSAD), and stores information regarding the vehicle 1 before and after an event such as an accident and information acquired by the in-vehicle sensor 26.

The driving automation control unit 29 controls a driving automation function of the vehicle 1. For example, the driving automation control unit 29 includes an analysis unit 61, an action planning unit 62, and an operation control unit 63.

The analysis unit 61 executes analysis processing on the vehicle 1 and a situation around the vehicle 1. The analysis unit 61 includes a self-position estimation unit 71, a sensor fusion unit 72, and a recognition unit 73.

The self-position estimation unit 71 estimates a self-position of the vehicle 1 on the basis of sensor data from the external recognition sensor 25 and the high-precision map accumulated in the map information accumulation unit 23. For example, the self-position estimation unit 71 generates a local map on the basis of the sensor data from the external recognition sensor 25, and estimates the self-position of the vehicle 1 by matching the local map with the high-precision map. The position of the vehicle 1 is based on, for example, a center of a rear wheel pair axle.

The local map is, for example, a three-dimensional high-precision map created using a technology such as simultaneous localization and mapping (SLAM), or the like, an occupancy grid map, or the like. The three-dimensional high-precision map is, for example, the above-described point cloud map or the like. The occupancy grid map is a map in which a three-dimensional or two-dimensional space around the vehicle 1 is divided into grids (lattices) of a predetermined size, and an occupancy state of an object is represented in units of grids. The occupancy state of the object is represented by, for example, the presence or absence or existence probability of the object. The local map is also used for detection processing and recognition processing on the situation outside the vehicle 1 by the recognition unit 73, for example.

Note that the self-position estimation unit 71 may estimate the self-position of the vehicle 1 on the basis of the position information acquired by position information acquisition unit 24 and sensor data from the vehicle sensor 27.

The sensor fusion unit 72 executes sensor fusion processing to obtain information by combining a plurality of different types of sensor data (for example, image data supplied from the camera 51 and sensor data supplied from the radar 52). The method for combining different types of sensor data include combination, integration, fusion, association, and the like.

The recognition unit 73 executes detection processing for detecting the situation outside the vehicle 1 and recognition processing for recognizing the situation outside the vehicle 1.

For example, the recognition unit 73 executes the detection processing and the recognition processing on the situation outside the vehicle 1 on the basis of information from the external recognition sensor 25, information from the self-position estimation unit 71, information from the sensor fusion unit 72, and the like.

Specifically, for example, the recognition unit 73 executes detection processing, recognition processing, and the like on an object around the vehicle 1. The object detection processing is, for example, processing of detecting presence or absence, size, shape, position, movement, and the like of an object. The object recognition processing is, for example, processing of recognizing an attribute such as a type of an object or the like or identifying a specific object. The detection processing and the recognition processing, however, are not necessarily clearly separated and may overlap.

For example, the recognition unit 73 detects an object around the vehicle 1 by performing clustering to classify point clouds based on sensor data from the LiDAR 53, the radar 52, or the like into clusters of point clouds. Thus, the presence or absence, size, shape, and position of the object around the vehicle 1 are detected.

For example, the recognition unit 73 detects a motion of the object around the vehicle 1 by performing tracking that follows a motion of the cluster of point clouds classified by clustering. Thus, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. Furthermore, the recognition unit 73 may recognize the type of the object around the vehicle 1 by executing recognition processing such as semantic segmentation.

For example, the recognition unit 73 can execute recognition processing on traffic rules around the vehicle 1 on the basis of a map accumulated in the map information accumulation unit 23, a result of estimation of the self-position by the self-position estimation unit 71, and a result of recognition of an object around the vehicle 1 by the recognition unit 73. Through this processing, the recognition unit 73 can recognize the position and the state of the traffic light, the details of the traffic sign and the road sign, the details of the traffic regulation, the travelable lane, and the like.

For example, the recognition unit 73 can perform recognition processing on a surrounding environment of the vehicle 1. As the surrounding environment to be recognized by the recognition unit 73, weather, temperature, humidity, brightness, road surface conditions, and the like are assumed.

The action planning unit 62 creates an action plan for the vehicle 1. For example, the action planning unit 62 creates an action plan by executing processing of path planning and path following.

Note that the path planning includes global path planning and local path planning. The global path planning includes processing of planning a rough path from the start to the goal. The local path planning is also called track planning, and includes processing of generating a track that enables safe and smooth traveling in the vicinity of the vehicle 1 in consideration of the motion characteristics of the vehicle 1 in the planned path.

The path following is processing of planning an operation for safely and accurately traveling a path planned by the path planning within a planned time. For example, the action planning unit 62 can calculate the target speed and the target angular velocity of the vehicle 1 on the basis of a result of the path following processing.

The operation control unit 63 controls the operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, and performs lateral vehicle movement control and longitudinal vehicle movement control in such a way that the vehicle 1 travels on the track calculated by the track planning. For example, the operation control unit 63 performs control for the purpose of implementing driver assistance functions such as collision avoidance or impact mitigation, follow-up traveling, vehicle speed maintaining traveling, collision warning of the host vehicle, and lane deviation warning of the host vehicle, and driving automation such as traveling without operation of the driver or the remote driver.

The DMS 30 executes authentication processing on the driver, recognition processing on a state of the driver, and the like on the basis of sensor data from the in-vehicle sensor 26, input data input to the HMI 31 to be described later, and the like. As the state of the driver to be recognized, for example, a physical condition, an alertness level, a concentration level, a fatigue level, a line-of-sight direction, a drunkenness level, a driving operation, a posture, and the like are assumed.

Note that the DMS 30 may execute authentication processing on a user other than the driver and recognition processing on a state of the user. Furthermore, for example, the DMS 30 may execute recognition processing on the conditions inside the vehicle on the basis of sensor data from the in-vehicle sensor 26. As the conditions inside the vehicle to be recognized, for example, temperature, humidity, brightness, odor, and the like are assumed.

The HMI 31 receives inputs of various data, instructions, and the like, and presents various data to the driver or the like.

The input of data through the HMI 31 will be schematically described. The HMI 31 includes an input device for a person to input data. The HMI 31 generates an input signal on the basis of data, an instruction, or the like input with the input device, and supplies the input signal to each unit of the vehicle control system 11. The HMI 31 includes, for example, an operation element such as a touch panel, a button, a switch, and a lever as the input device. It is not limited thereto, and the HMI 31 may further include an input device capable of inputting information by a method such as voice, gesture, or the like other than manual operation. Moreover, the HMI 31 may use, for example, a remote control device using infrared rays or radio waves, or an external connection device such as a mobile device or a wearable device adapted to the operation of the vehicle control system 11 as an input device.

Presentation of data by the HMI 31 will be schematically described. The HMI 31 generates visual information, auditory information, and tactile information for the user or the outside of the vehicle. Furthermore, the HMI 31 performs output control for con-trolling the output, output content, output timing, output method, and the like of each piece of generated information. The HMI 31 generates and outputs, as the visual information, an operation screen, a state display of the vehicle 1, a warning display, an image such as a monitor image indicating a situation around the vehicle 1, and information indicated by light, for example. Furthermore, the HMI 31 generates and outputs, as the auditory information, information indicated by sounds such as voice guidance, a warning sound, and a warning message, for example. Moreover, the HMI 31 generates and outputs, as the tactile information, information given to the tactile sense of the user by force, vibration, motion, or the like, for example.

As an output device that the HMI 31 outputs the visual information, for example, a display device that presents the visual information by displaying an image by itself or a projector device that presents the visual information by projecting an image can be applied. Note that the display device may be a device that displays the visual information in the field of view of the user, such as a head-up display, a transmissive display, or a wearable device having an augmented reality (AR) function, for example, in addition to a display device having a normal display. Furthermore, in the HMI 31, a display device included in a navigation device, an instrument panel, a camera monitoring system (CMS), an electronic mirror, a lamp, or the like provided in the vehicle 1 can also be used as the output device that outputs the visual information.

As an output device from which the HMI 31 outputs the auditory information, for example, an audio speaker, a headphone, or an earphone can be applied.

As an output device to which the HMI 31 outputs the tactile information, for example, a haptic element using a haptic technology can be applied. The haptics element is provided, for example, at a portion with which the user comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a steering ECU that controls the steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of a state of a drive system of the vehicle 1. The drive system includes, for example, an accelerator pedal, a driving force generation device for generating a driving force such as an internal combustion engine or a driving motor, a driving force transmission mechanism for transmitting the driving force to wheels, and the like. The drive control unit 83 includes, for example, a drive ECU that controls the drive system, an actuator that drives the drive system, and the like.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 performs detection, control, and the like of states of various lights of the vehicle 1. As the lights to be controlled, for example, a headlight, a backlight, a fog light, a turn signal, a brake light, a projection, a bumper display, and the like are assumed. The light control unit 85 includes a light ECU that controls the lights, an actuator that drives the lights, and the like.

The horn control unit 86 performs detection, control, and the like of a state of a car horn of the vehicle 1. The horn control unit 86 includes, for example, a horn ECU that controls the car horn, an actuator that drives the car horn, and the like.

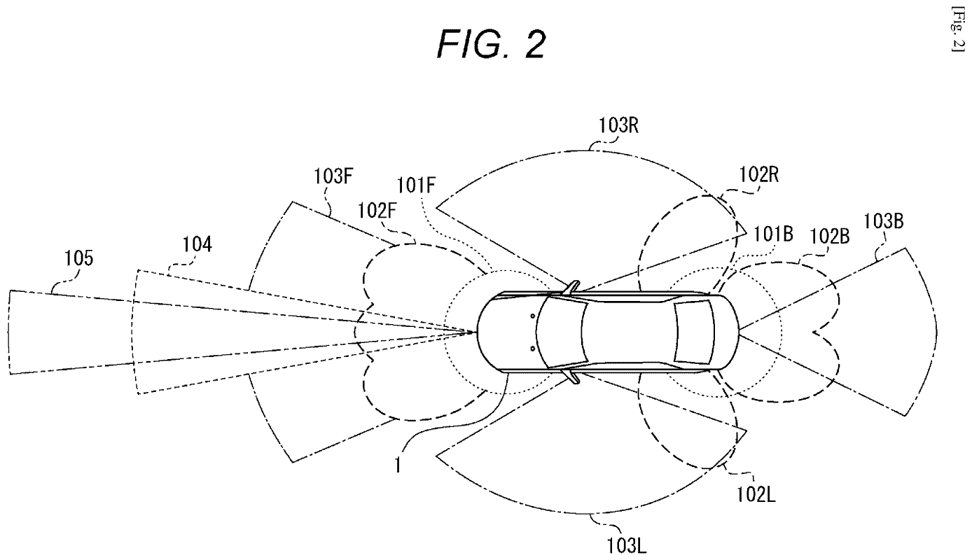

FIG. 2 is a diagram depicting examples of sensing areas of the camera 51, the radar 52, the LiDAR 53, the ultrasonic sensor 54, and the like of the external recognition sensor 25 in FIG. 1. Note that FIG. 2 schematically depicts the vehicle 1 as viewed from above, where a left end side is the front end (front) side of the vehicle 1 and a right end side is the rear end (rear) side of the vehicle 1.

Sensing areas 101F and 101B illustrate examples of sensing areas of the ultrasonic sensor 54. The sensing area 101F covers an area around the front end of the vehicle 1 by a plurality of the ultrasonic sensors 54. The sensing area 101B covers an area around the rear end of the vehicle 1 by a plurality of the ultrasonic sensors 54.

Sensing results in the sensing area 101F and the sensing area 101B are used for, for example, parking assistance and the like of the vehicle 1.

Sensing areas 102F to 102B illustrate examples of sensing areas of a short-range or medium-range radar 52. The sensing area 102F covers an area extending farther than the sensing area 101F in front of the vehicle 1. The sensing area 102B covers an area extending farther than the sensing area 101B behind the vehicle 1. The sensing area 102L covers an area around the rear-left side of the vehicle 1. The sensing area 102R covers an area around the rear-right side of the vehicle 1.

A sensing result in the sensing area 102F is used for, for example, detection of a vehicle, a pedestrian, or the like present in front of the vehicle 1, and the like. A sensing result in the sensing area 102B is used for, for example, a function of preventing a collision of the rear of the vehicle 1, and the like. Sensing results in the sensing areas 102L and 102R are used for, for example, detection of an object in a blind spot on the sides of the vehicle 1, and the like.

Sensing areas 103F to 103B illustrate examples of sensing areas of the camera 51. The sensing area 103F covers an area extending farther than the sensing area 102F in front of the vehicle 1. The sensing area 103B covers an area extending farther than the sensing area 102B behind the vehicle 1. The sensing area 103L covers an area around the left side of the vehicle 1. The sensing area 103R covers an area around the right side of the vehicle 1.

A sensing result in the sensing area 103F can be used for, for example, recognition of a traffic light or a traffic sign, a lane departure prevention assist system, and an automatic headlight control system. A sensing result in the sensing area 103B is used for, for example, parking assistance, a surround view system, and the like. Sensing results in the sensing areas 103L and 103R can be used for, for example, a surround view system.

A sensing area 104 illustrates an example of a sensing area of the LiDAR 53. The sensing area 104 covers an area extending farther than the sensing area 103F in front of the vehicle 1. Meanwhile, the sensing area 104 has a narrower range in a left-right direction than the sensing area 103F.

A sensing result in the sensing area 104 is used for, for example, detection of an object such as a neighboring vehicle.

A sensing area 105 illustrates an example of a sensing area of a long-range radar 52. The sensing area 105 covers an area extending farther than the sensing area 104 in front of the vehicle 1. Meanwhile, the sensing area 105 has a narrower range in the left-right direction than the sensing area 104.

A sensing result in the sensing area 105 is used for, for example, adaptive cruise control (ACC), emergency braking, collision avoidance, and the like.

Note that the respective sensing areas of the sensors: the camera 51; the radar 52; the LiDAR 53; and the ultrasonic sensor 54, included in the external recognition sensor 25 may have various configurations other than those in FIG. 2. Specifically, the ultrasonic sensor 54 may also perform sensing on the sides of the vehicle 1, or the LiDAR 53 may perform sensing on the rear of the vehicle 1. Furthermore, the installation position of each sensor is not limited to each example described above. Furthermore, the number of sensors may be one or more.

### 2. Background of Present Technology

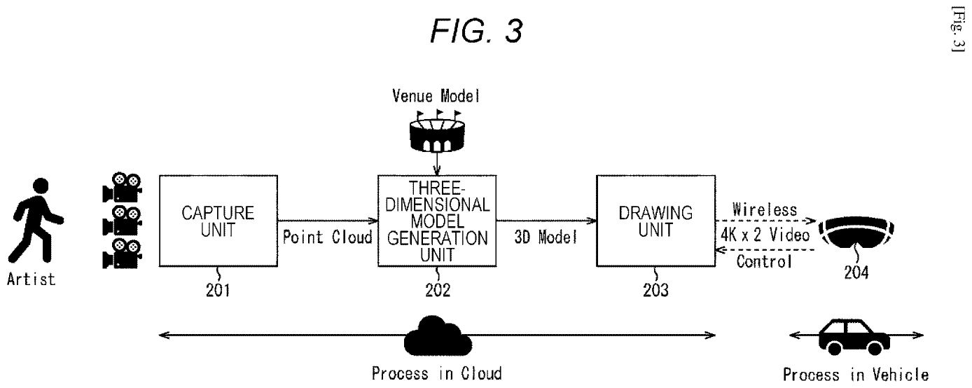

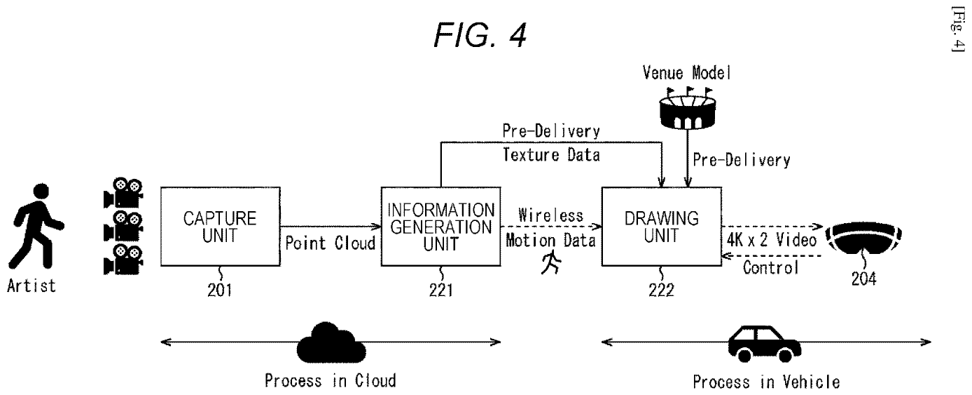

Next, the background of the present technology will be described with reference to FIGS. 3 and 4.

FIG. 3 illustrates an outline of a flow of processing according to the related art in a case where an entertainment content including a free-viewpoint video of an event such as a concert is live-streamed to the vehicle 1.

For example, a capture unit 201, a three-dimensional model generation unit 202, and a drawing unit 203 are disposed on a cloud side (server side). A head mounted display (HMD) 204 is disposed on a vehicle 1 side. A user (passenger) views a content in the vehicle 1 by using the HMD 204.

The capture unit 201 generates a point cloud by using a volumetric capture technology (volumetric video technology) on the basis of, for example, videos captured in respective directions by a plurality of cameras disposed to surround a place (hereinafter, referred to as an event venue) where an event is held. The capture unit 201 supplies the generated point cloud to the three-dimensional model generation unit 202.

The three-dimensional model generation unit 202 generates a three-dimensional model (hereinafter, referred to as a three-dimensional event model) representing each scene of a content (event) on the basis of a point cloud and a three-dimensional model (hereinafter, referred to as a venue model) of an event venue generated in advance. The three-dimensional model generation unit 202 supplies the generated three-dimensional event model to the drawing unit 203.

The drawing unit 203 includes, for example, a renderer or the like. The drawing unit 203 receives control information of the HMD 204 from the vehicle 1 by wireless communication of a predetermined scheme. The control information includes information regarding the field of view of the user using the HMD 204 (hereinafter, referred to as field-of-view information). The field-of-view information includes, for example, information regarding a motion of the user (for example, a motion of the head or the line-of-sight) and an operation content with respect to a display range (field-of-view range) of the HMD 204.

The drawing unit 203 cuts out a video to be displayed on the HMD 204 from the three-dimensional event model on the basis of the control information. For example, the drawing unit 203 cuts out a video including a range corresponding to the field-of-view range of the user from the three-dimensional event model on the basis of the control information. The drawing unit 203 transmits video information indicating the cut-out video to the vehicle 1 by wireless communication of a predetermined scheme.

The communication unit 22 of the vehicle 1 receives the video information from the drawing unit 203 by wireless communication of a predetermined scheme. The communication unit 22 transmits the video information to the HMD 204.

The HMD 204 displays a video based on the video information.

Here, in a case of viewing a content of a free-viewpoint video by using the HMD 204, it is necessary to suppress motion-to-photon latency within 10 ms in order to prevent virtual reality (VR) sickness. The motion-to-photon latency is a time taken from when the field of view of the user (for example, the orientation of the face and a line-of-sight direction) moves to when a video corresponding to the field of view after the movement is displayed.

On the other hand, for example, the resolution of a video of a content displayed on each display of the HMD 204 is 4000 pixels×2000 pixels, a frame rate is 120 fps, a bit depth is 12 bits, and RGB subsampling is 4:4:4. In this case, a data rate of the video information supplied to each display of the HMD 204 is 4000×2000×120×12×3=34.56 Gbps. Since the HMD 204 includes two displays, the data rate of the video information supplied to the HMD 204 is 69.12 Gbps.

Furthermore, in a case where sound of the content is modulated by linear pulse code modulation (PCM), a data rate of the sound of each channel is 1.5 Mbps, and the number of channels is 32, a data rate of the sound information is 1.5 Mbps×32 ch=4.6 Mbps.

As described above, since it is necessary to suppress the motion-to-photon latency within 10 ms, it is difficult to compress the video information and the sound information at a high compression rate. Therefore, for example, it is required to secure a wireless communication line at a transmission speed of 69.12 Gbps or more from the drawing unit 203 to the HMD 204, but this is very difficult.

Therefore, it is difficult to secure a wireless communication line necessary for transmitting the video information and the sound information with almost no delay, and there is a possibility that the quality (for example, image quality) of the content is deteriorated or the quality of the content needs to be deteriorated. Furthermore, the motion-to-photon latency becomes long, and there is a possibility that VR sickness of the user is caused.

On the other hand, it is conceivable to dispose a drawing unit 222 on the vehicle 1 side as illustrated in FIG. 4. Note that, in FIG. 4, portions corresponding to those in FIG. 3 are denoted by the same reference signs, and a description thereof will be omitted as appropriate.

For example, the capture unit 201 and the information generation unit 221 are disposed on the cloud side (server side). The drawing unit 222 and the HMD 204 are disposed on the vehicle 1 side.

The information generation unit 221 generates texture information and motion information on the basis of the point cloud generated by the capture unit 201.

The texture information includes, for example, information regarding an appearance of a performer of the event. The information generation unit 221 generates the texture information on the basis of a point cloud generated before the start of the event and transmits the texture information to the vehicle 1 before the start of the event.

The motion information includes, for example, information regarding a motion of a performer during the event and a motion in a production. The information generation unit 221 generates the motion information on the basis of a point cloud generated during the event, and performs live streaming distribution to the vehicle 1.

The drawing unit 222 acquires the three-dimensional model (venue model) of the event venue before the start of the event. The drawing unit 222 generates the three-dimensional event model representing each scene of the content (event) on the basis of the venue model and the texture information acquired in advance and the motion information received by live streaming distribution from the information generation unit 221 during the event.

The drawing unit 203 cuts out a video to be displayed on the HMD 204 from the three-dimensional event model on the basis of the control information supplied from the HMD 204. The drawing unit 203 transmits video information indicating the cut-out video to the HMD 204 by predetermined wireless communication.

The HMD 204 displays a video based on the video information.

In this case, the amount of data transmitted between the cloud (the information generation unit 221) and the vehicle 1 during live streaming distribution can be suppressed. As a result, the quality of the content is stabilized, and the motion-to-photon latency is shortened.

On the other hand, the drawing unit 222 on the vehicle 1 side generates a video of a performer or the like on the basis of the texture information acquired in advance. Therefore, for example, it is not possible to provide the user with an experience rich in interactivity such as a call and response rally with a performer.

On the other hand, the present technology makes it possible to suppress deterioration in quality of a content viewed in the moving body such as the vehicle 1. In addition, the present technology makes it possible to improve interactivity of a content while suppressing deterioration in quality of the content.

### 3. First Embodiment

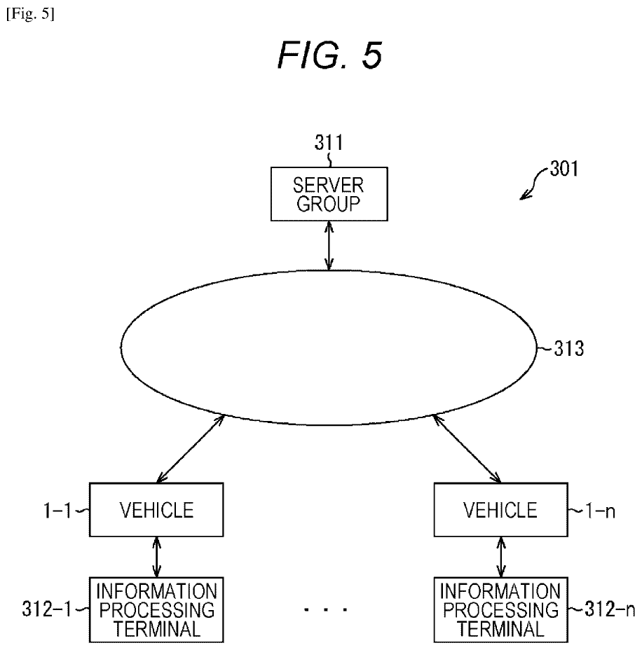

Next, a first embodiment of the present technology will be described with reference to FIGS. 5 to 12.

### Configuration Example of Information Processing System 301

FIG. 5 illustrates a configuration example of an information processing system 301 that is the first embodiment of the information processing system to which the present technology is applied.

The information processing system 301 includes a server group 311, vehicles 1-1 to 1-n, and information processing terminals 312-1 to 312-n. The server group 311 and the vehicles 1-1 to 1-n are connected to each other via a network 313.

Hereinafter, in a case where it is not necessary to individually distinguish the vehicles 1-1 to 1-n, they are simply referred to as the vehicle 1. Hereinafter, the information processing terminals 312-1 to 312-n are simply referred to as an information processing terminal 312 in a case where it is not necessary to individually distinguish from each other.

The server group 311 includes one or more servers. The server group 311 distributes various contents to each vehicle 1 via the network 313.

The information processing terminal 312 is used to view the content distributed from the server group 311 in each vehicle 1. For example, the information processing terminal 312 includes a display device with which a content of a free-viewpoint video is viewable.

Note that the information processing terminal 312 may include two or more devices. For example, the information processing terminal 312 includes an HMD and a controller.

Furthermore, two or more information processing terminals 312 may be used in each vehicle 1.

### Functional Configuration Example of Server Group 311

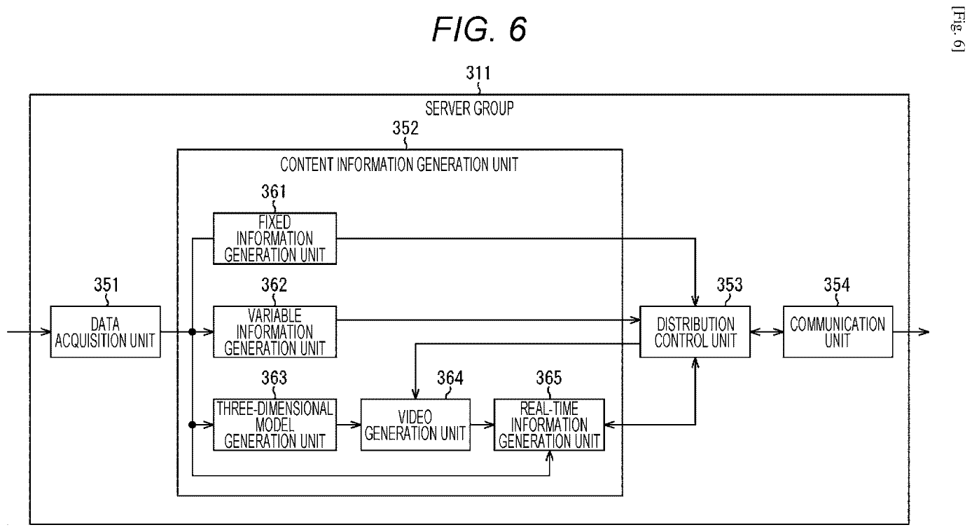

FIG. 6 illustrates a functional configuration example of the server group 311. The server group 311 includes a data acquisition unit 351, a content information generation unit 352, a distribution control unit 353, and a communication unit 354. The content information generation unit 352 includes a fixed information generation unit 361, a variable information generation unit 362, a three-dimensional model generation unit 363, a video generation unit 364, and a real-time information generation unit 365.

Note that the functions of the server group 311 in FIG. 6 may be implemented by one server or may be implemented by two or more servers.

The data acquisition unit 351 acquires various data regarding a content to be distributed, and supplies the acquired data to the fixed information generation unit 361, the variable information generation unit 362, the three-dimensional model generation unit 363, and the real-time information generation unit 365.

For example, the data acquisition unit 351 collects fixed information that is basically unchanged in the content to be distributed, and supplies the fixed information to the fixed information generation unit 361.

For example, the data acquisition unit 351 includes a plurality of cameras disposed in such a way as to surround the event venue where the event that is a target of the content to be distributed is held. The data acquisition unit 351 generates a point cloud representing each scene of the content (event) by using the volumetric capture technology on the basis of a video captured in each direction by each camera. The data acquisition unit 351 supplies the generated point cloud to the variable information generation unit 362 and the three-dimensional model generation unit 363.

For example, the data acquisition unit 351 includes one or more microphones disposed at the event venue. The data acquisition unit 351 generates the sound information on the basis of a sound signal indicating a sound collected by each microphone. The data acquisition unit 351 supplies the generated sound information to the variable information generation unit 362 and the real-time information generation unit 365.

The fixed information generation unit 361 generates the fixed information that is information fixed in the content on the basis of the data supplied from the data acquisition unit 351. The fixed information generation unit 361 supplies the generated fixed information to the distribution control unit 353. Details of the fixed information will be described later.

The variable information generation unit 362 generates, on the basis of the data supplied from the data acquisition unit 351, information that is not fixed in the content, in other words, variable information that is information varying according to the content. The variable information generation unit 362 supplies the generated variable information to the distribution control unit 353. Details of the variable information will be described later.

The three-dimensional model generation unit 363 generates the three-dimensional event model representing each scene of the content (event) on the basis of the data supplied from the data acquisition unit 351. The three-dimensional model generation unit 363 supplies the generated three-dimensional event model to the video generation unit 364.

The video generation unit 364 includes, for example, a renderer or the like. The video generation unit 364 cuts out a video to be presented to the user from the three-dimensional event model on the basis of the control information received from the vehicle 1 via the distribution control unit 353 or the like. The control information includes the field-of-view information as described above. The video generation unit 364 supplies the video information indicating the cut-out video to the real-time information generation unit 365.

The real-time information generation unit 365 generates real-time information on the basis of the data supplied from the data acquisition unit 351 and the video information supplied from the video generation unit 364. The real-time information is, for example, information indicating each scene of the content (event) substantially in real time. The real-time information generation unit 365 supplies the generated real-time information to the distribution control unit 353.

Note that the real-time information includes at least two types of real-time information including high-definition real-time information including video information with a high definition (hereinafter, referred to as high-definition video information) and small-size real-time information including video information with a small size (hereinafter, referred to as small-size video information). A video based on the high-definition video information has a higher definition and a higher quality than a video based on the small-size video information. In other words, the video based on the small-size video information is coarser and lower in quality than the video based on the high-definition video information.

The distribution control unit 353 controls distribution of the content to each vehicle 1 via the communication unit 354. For example, the distribution control unit 353 transmits the fixed information, the variable information, and the real-time information to each vehicle via the communication unit 354 according to a request from the vehicle 1.

The communication unit 354 communicates with the communication unit 22 of each vehicle 1 via the network 313 by a predetermined communication scheme. Note that, as a communication scheme of the communication unit 354, a high-speed and stable communication scheme is adopted so that a large-size entertainment content can be stably distributed.

### Functional Configuration Example of Information Processing Unit 401 and Information Processing Terminal 312 of Vehicle 1

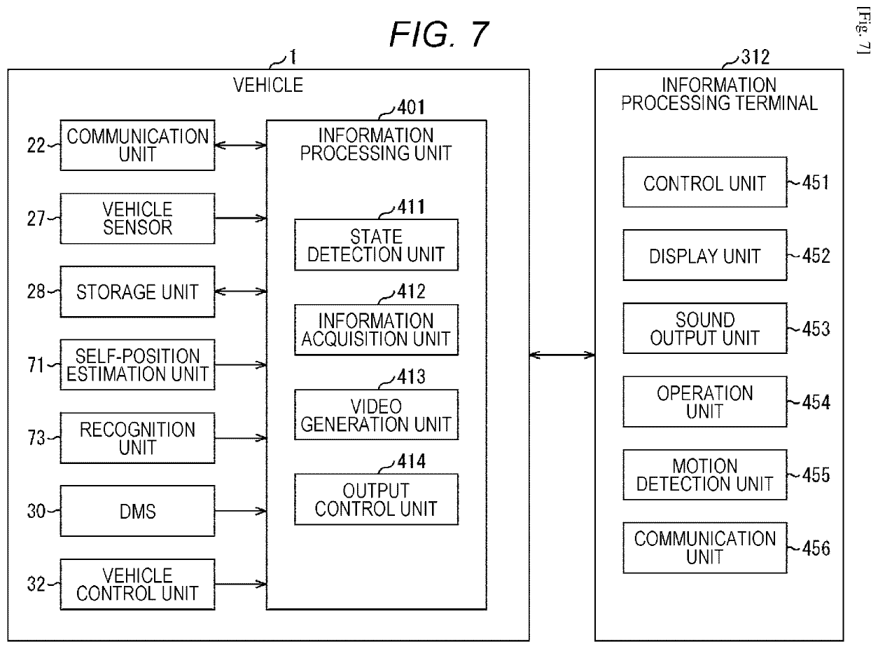

FIG. 7 illustrates a functional configuration example of an information processing unit 401 and the information processing terminal 312 of the vehicle 1.

The information processing unit 401 of the vehicle 1 executes processing related to processing of reproducing the content distributed from the server group 311 in the information processing terminal 312. The information processing unit 401 includes a state detection unit 411, an information acquisition unit 412, a video generation unit 413, and an output control unit 414.

The state detection unit 411 detects a movement state of the vehicle 1 on the basis of one or more of various data received from the outside or the inside of the vehicle by the communication unit 22, sensor data from the vehicle sensor 27, a result of estimating the self-position of the vehicle 1 by the self-position estimation unit 71, a result of recognizing the situation outside the vehicle 1 by the recognition unit 73, and a result of detecting the state of each unit of the vehicle 1 by the vehicle control unit 32. The movement state of the vehicle 1 includes, for example, at least one of a place where the vehicle 1 is traveling (moving), the state around the vehicle 1, or the state of the vehicle 1.

The information acquisition unit 412 receives information regarding the content distributed from the server group 311 via the network 313 and the communication unit 22. For example, the information acquisition unit 412 receives the fixed information, the variable information, and the real-time information from the server group 311 via the network 313 and the communication unit 22. At this time, for example, the information acquisition unit 412 selects information to be acquired from the server group 311 on the basis of the movement state of the vehicle 1 detected by the state detection unit 411.

The video generation unit 413 includes, for example, a renderer or the like. The video generation unit 413 generates the video information of the content on the basis of the fixed information and the variable information.

The output control unit 414 controls output of the content (for example, the video information, the sound information, and the like) to the information processing terminal 312. For example, the output control unit 414 transmits the video information, the sound information, and the real-time information of the content to the information processing terminal 312 via the communication unit 22. At this time, for example, the output control unit 414 selects information (for example, the video information or the like) to be transmitted to the information processing terminal 312 on the basis of the movement state of the vehicle 1 detected by the state detection unit 411.

The information processing terminal 312 includes a control unit 451, a display unit 452, a sound output unit 453, an operation unit 454, a motion detection unit 455, and a communication unit 456.

The control unit 451 executes various types of processing in the information processing terminal 312 and controls each unit.

The display unit 452 includes a display device such as a display. The display unit 452 displays a video based on the video information of the content. The display unit 452 can display, for example, a free-viewpoint video or a three-dimensional video.

The sound output unit 453 includes a sound output device such as a speaker or a headphone. The sound output unit 453 outputs a sound based on the sound information of the content.

The operation unit 454 includes various operation devices and is used for operating the information processing terminal 312.

The motion detection unit 455 includes various sensors and the like, and detects a motion of the user on the basis of the sensor data from each sensor or the like. For example, the motion detection unit 455 detects a motion of the head or the line-of-sight of the user.

The communication unit 456 communicates with the communication unit 22 of the vehicle 1 by a predetermined communication scheme. The communication scheme of the communication unit 456 may be either wired communication or wireless communication. Note that, as a communication scheme of the communication unit 354, a high-speed and stable communication scheme is adopted so that a large-size entertainment content can be stably distributed. For example, optical wireless communication is used as the communication scheme of the communication unit 456.

### Processing in Information Processing System 301

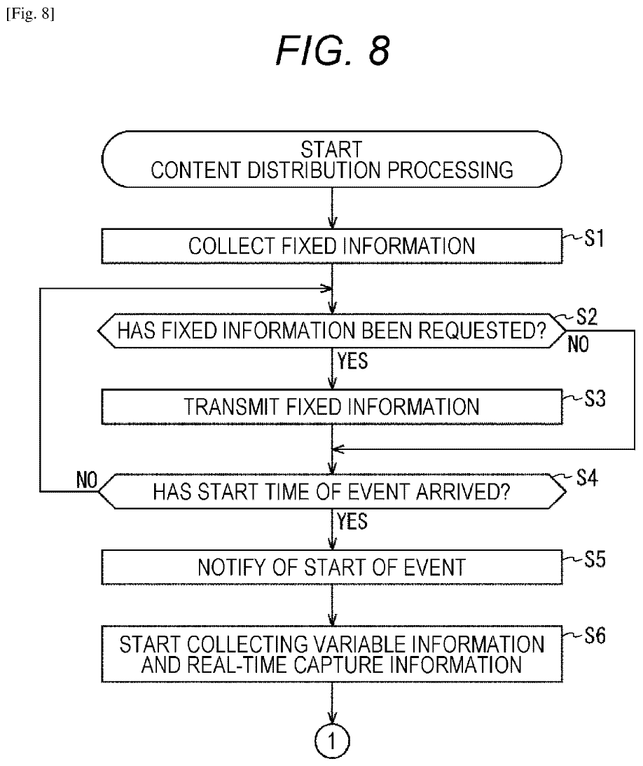

Next, processing in the information processing system 301 will be described with reference to FIGS. 8 to 12.

Note that, hereinafter, an example will be described in which the server group 311 performs live streaming distribution (live distribution and real-time distribution) of a content including a free-viewpoint video of an event such as a concert in substantially real time.

### Content Distribution Processing

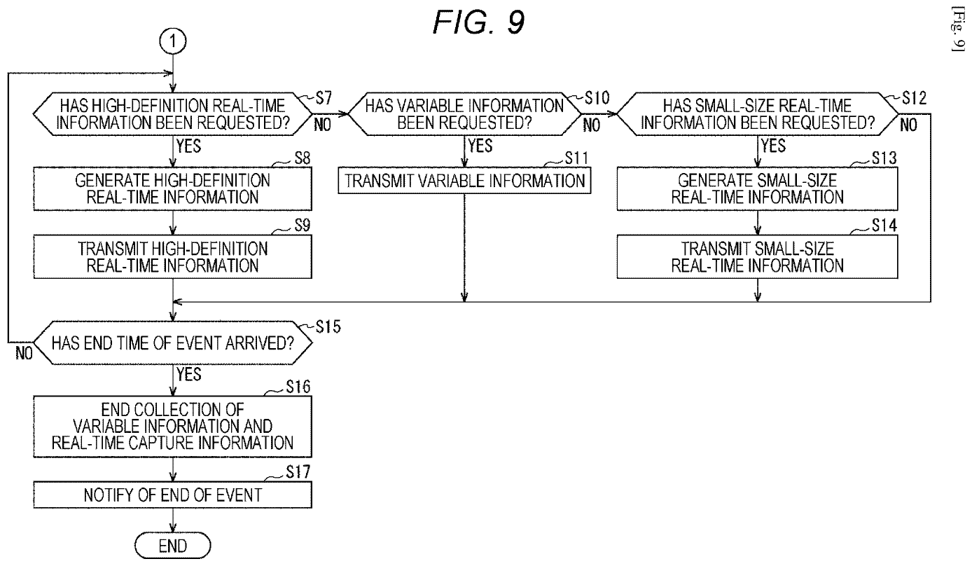

First, content distribution processing executed by the server group 311 will be described with reference to flowcharts of FIGS. 8 and 9.

The processing is started, for example, at the time and date when the content distribution processing is to be started. The date and time when the content distribution processing is to be started is set to be earlier than the date and time when the event is to be started.

In step S1, the server group 311 collects the fixed information. For example, the data acquisition unit 351 collects information regarding the event to be live-streamed and fixed without basically changing during the live streaming distribution of the content, and supplies the information to the fixed information generation unit 361.

The fixed information generation unit 361 generates the fixed information on the basis of the information collected by the data acquisition unit 351.

The fixed information includes, for example, event venue information, performer appearance information, production planning information, other audience appearance information, and the like. The event venue information includes information regarding the event venue, for example, high-definition three-dimensional map information of the event venue. The performer appearance information includes information regarding an appearance of a performer, for example, high-definition texture information of the performer. The production planning information includes, for example, information regarding planning of various types of production of the event such as lighting and fireworks. The other audience appearance information includes information regarding appearances of other audiences other than the user, for example, avatar information of another audience. Note that the avatar information of the another audience may be different from the actual appearance of the another audience.

In step S2, the distribution control unit 353 determines whether or not the fixed information has been requested. In a case where a signal for requesting the fixed information (hereinafter, referred to as a fixed information request signal) is received from the vehicle 1 via the network 313 and the communication unit 354, the distribution control unit 353 determines that the fixed information has been requested, and the processing proceeds to step S3.

In step S3, the server group 311 transmits the fixed information. Specifically, the distribution control unit 353 acquires the fixed information from the fixed information generation unit 361. The distribution control unit 353 transmits the fixed information to the vehicle 1 as the requester via the communication unit 354 and the network 313.

Thereafter, the processing proceeds to step S4.

On the other hand, in a case where it is determined in step S2 that the fixed information has not been requested, the processing in step S3 is skipped, and the processing proceeds to step S4.

In step S4, the distribution control unit 353 determines whether or not a start time of the event has arrived. In a case where it is determined that the start time has not arrived, the processing returns to step S2.

Thereafter, the processing in steps S2 to S4 is repeatedly executed until it is determined in step S4 that the start time of the event has arrived.

On the other hand, in a case where it is determined in step S4 that the start time of the event has arrived, the processing proceeds to step S5.

In step S5, the distribution control unit 353 notifies of the start of the event.

Specifically, the distribution control unit 353 generates an event start notification signal for notifying of the start of the event, and transmits the event start notification signal to each vehicle 1 via the communication unit 354 and the network 313.

In step S6, the server group 311 starts collecting the variable information and real-time capture information.

For example, the data acquisition unit 351 starts processing of imaging the event venue with the plurality of cameras disposed to surround the event venue. The data acquisition unit 351 starts processing of generating the point cloud representing each scene of the content (event) by using the volumetric capture technology on the basis of the video captured in each direction by each camera. The data acquisition unit 351 starts processing of supplying the generated point cloud to the variable information generation unit 362 and the three-dimensional model generation unit 363.

For example, the data acquisition unit 351 starts processing of collecting sounds of the event venue by a microphone disposed at each place in the event venue. The data acquisition unit 351 starts processing of generating the sound information on the basis of a sound signal indicating the sound collected by each microphone and supplying the sound information to the variable information generation unit 362 and the real-time information generation unit 365.

The variable information generation unit 362 starts processing of generating the variable information on the basis of the point cloud and the sound information supplied from the data acquisition unit 351.

The variable information includes, for example, performer motion information, other audience motion information, production motion information, the sound information, and the like. The performer motion information includes information regarding a motion of a performer. The motion of the performer includes, for example, not only a motion of the body of the performer but also a motion of a facial expression. The other audience motion information includes information regarding a motion of another audience during the event. The performance motion information includes information regarding various motions in a production such as a lighting direction and a firework timing.

The three-dimensional model generation unit 363 starts processing of generating the three-dimensional event model representing each scene of the content (event) on the basis of the point cloud supplied from the data acquisition unit 351 and supplying the three-dimensional event model to the video generation unit 364.

In step S7, the distribution control unit 353 determines whether or not the high-definition real-time information has been requested. In a case where a signal for re-questing the high-definition real-time information (hereinafter, referred to as a high-definition real-time information request signal) is received from the vehicle 1 via the network 313 and the communication unit 354, the distribution control unit 353 determines that the high-definition real-time information has been requested, and the processing proceeds to step S8.

The high-definition real-time request signal includes, for example, the control information including the field-of-view information described above.

In step S8, the server group 311 generates the high-definition real-time information. For example, the video generation unit 364 cuts out a video including a range corresponding to the field-of-view range of the user as it is from the three-dimensional event model without reducing the resolution, on the basis of the control information included in the high-definition real-time information request signal. The video generation unit 364 supplies the high-definition video information indicating the cut-out video to the real-time information generation unit 365.

The real-time information generation unit 365 generates the high-definition real-time information including the high-definition video information and the sound information corresponding to the high-definition video information. The sound information corresponding to the high-definition video information is sound information indicating a sound output in synchronization with the video based on the high-definition video information. The real-time information generation unit 365 supplies the high-definition real-time information to the distribution control unit 353.

In step S9, the server group 311 transmits the high-definition real-time information. Specifically, the distribution control unit 353 transmits the high-definition real-time information to the vehicle 1 as the requester via the communication unit 354 and the network 313.

Thereafter, the processing proceeds to step S15.

On the other hand, in a case where it is determined in step S7 that the high-definition real-time information has not been requested, the processing proceeds to step S10.

In step S10, the distribution control unit 353 determines whether or not the variable information has been requested. In a case where a signal for requesting the variable information (hereinafter, referred to as a variable information request signal) is received from the vehicle 1 via the network 313 and the communication unit 354, the distribution control unit 353 determines that the variable information has been requested, and the processing proceeds to step S11.

In step S11, the server group 311 transmits the variable information. Specifically, the distribution control unit 353 acquires the variable information from the variable information generation unit 362. The distribution control unit 353 transmits the variable information to the vehicle 1 as the requester via the communication unit 354 and the network 313.

Thereafter, the processing proceeds to step S15.

On the other hand, in a case where it is determined in step S10 that the variable information has not been requested, the processing proceeds to step S12.

In step S12, the distribution control unit 353 determines whether or not the small-size real-time information has been requested. In a case where a signal for requesting the small-size real-time information (hereinafter, referred to as a small-size real-time information request signal) is received from the vehicle 1 via the network 313 and the communication unit 354, the distribution control unit 353 determines that the small-size real-time information has been requested, and the processing proceeds to step S13.

In step S13, the server group 311 generates the small-size real-time information. For example, the video generation unit 364 cuts out a video of a predetermined range with a reduced resolution from the three-dimensional event model. The video generation unit 364 supplies the small-size video information indicating the cut-out video to the real-time information generation unit 365.

Note that, for example, a range in which the video is cut out is fixed regardless of the field-of-view range of the user. That is, a video of a predetermined angle is cut out from the three-dimensional event model. As a result, a time for generating the small-size video information is shortened.

The real-time information generation unit 365 generates the small-size real-time information including the small-size video information and the sound information corresponding to the small-size video information. The real-time information generation unit 365 supplies the small-size real-time information to the distribution control unit 353.

In step S14, the server group 311 transmits the small-size real-time information. Specifically, the distribution control unit 353 transmits the small-size real-time information to the vehicle 1 as the requester via the communication unit 354 and the network 313.

Thereafter, the processing proceeds to step S15.

On the other hand, in a case where it is determined in step S12 that the small-size real-time information has not been requested, the processing in steps S13 and S14 is skipped, and the processing proceeds to step S15.

In step S15, the distribution control unit 353 determines whether or not an end time of the event has arrived. In a case where it is determined that the end time of the event has not arrived, the processing returns to step S7.

Thereafter, the processing in steps S7 to S15 is repeatedly executed until it is determined in step S15 that the end time of the event has arrived. As a result, the high-definition real-time information, the variable information, or the small-size real-time information is transmitted to the vehicle 1 as the requester in response to a request from the vehicle 1.

On the other hand, in a case where it is determined in step S15 that the end time of the event has arrived, the processing proceeds to step S16.

In step S16, the server group 311 ends the collection of the variable information and the real-time capture information. That is, the processing started in the processing in step S6 ends.

In step S17, the distribution control unit 353 notifies of the end of the event. Specifically, the distribution control unit 353 generates an event end notification signal for notifying of the end of the event, and transmits the event start notification signal to each vehicle 1 via the communication unit 354 and the network 313.

Thereafter, the content distribution processing ends.

### Content Reproduction Processing

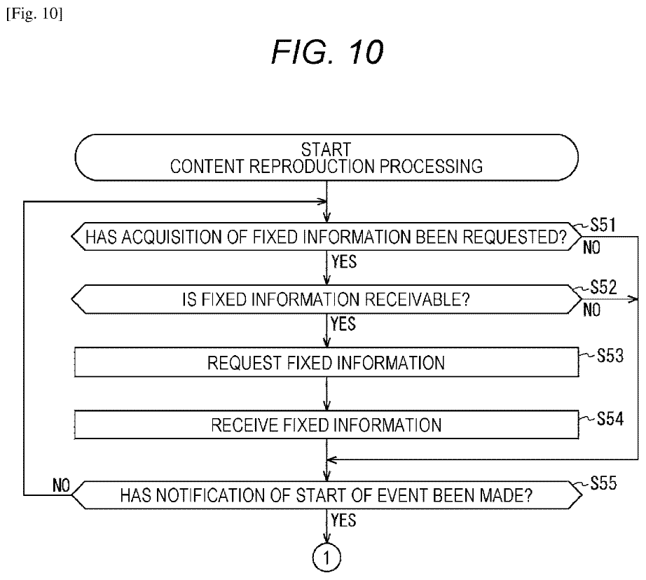

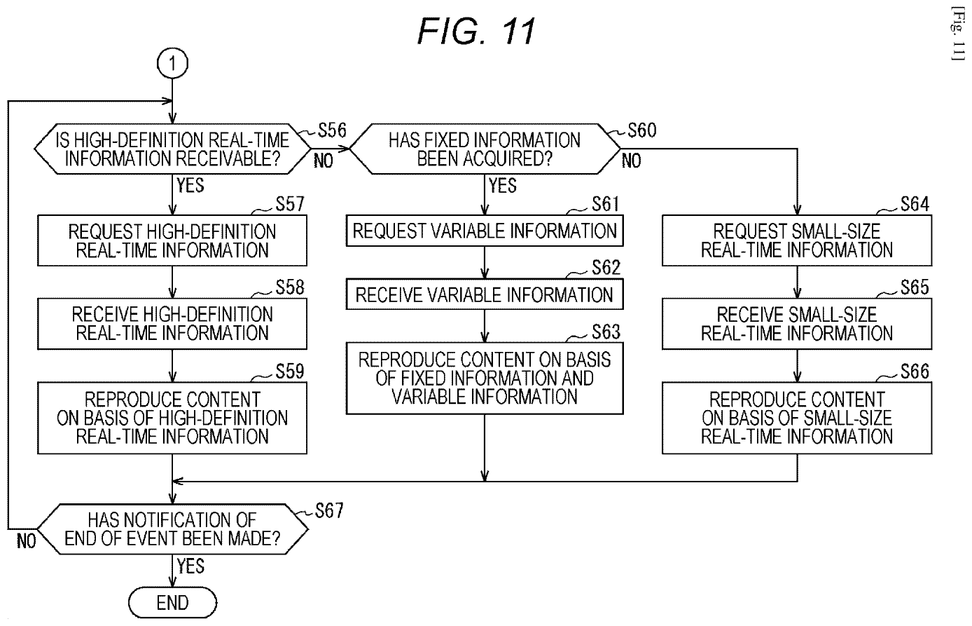

Next, content reproduction processing executed by the vehicle 1 and the information processing terminal 312 corresponding to the content distribution processing by the server group 311 in FIGS. 8 and 9 will be described with reference to the flowcharts of FIGS. 10 and 11.

In step S51, the information acquisition unit 412 of the vehicle 1 determines whether or not acquisition of the fixed information has been requested.

For example, in a case where acquisition of the fixed information has been requested, the user performs an operation for acquiring the fixed information via the operation unit 454 of the information processing terminal 312. Then, the communication unit 456 transmits a corresponding operation signal to the vehicle 1.

On the other hand, in a case where the operation signal is received via the communication unit 22, the information acquisition unit 412 of the vehicle 1 determines that acquisition of the fixed information has been requested, and the processing proceeds to step S52.

In step S52, the state detection unit 411 of the vehicle 1 determines whether or not the fixed information is receivable. Specifically, the state detection unit 411 detects the movement state of the vehicle 1 on the basis of one or more of various data received from the outside or the inside of the vehicle by the communication unit 22, the sensor data from the vehicle sensor 27, a result of estimating the self-position of the vehicle 1 by the self-position estimation unit 71, a result of recognizing the situation outside the vehicle 1 by the recognition unit 73, and a result of detecting the state of each unit of the vehicle 1 by the vehicle control unit 32.

In a case where it is estimated that the movement state of the vehicle 1 is a state in which a communication line with a predetermined speed or higher for content distribution can be stably secured, the state detection unit 411 determines that the fixed information is receivable. For example, in a case where the vehicle 1 is stopped and the communication unit 22 is connected to the network 313 via a communication line of a predetermined communication scheme, the state detection unit 411 determines that the fixed information is receivable. Examples of the case of being connected to the network 313 via a communication line of a predetermined communication scheme include a case of being connected to the network 313 via a high-speed wireless communication line such as a millimeter wave, a case of being connected to the network 313 via a wired communication line by a communication cable or a communicable charging cable, or the like. Then, in a case where it is determined that the fixed information is receivable, the processing proceeds to step S53.

In step S53, the information acquisition unit 412 of the vehicle 1 requests the fixed information. Specifically, the information acquisition unit 412 generates the fixed information request signal and transmits the fixed information request signal to the server group 311 via the communication unit 22 and the network 313.

In step S54, the information acquisition unit 412 of the vehicle 1 receives the fixed information. Specifically, the information acquisition unit 412 receives the fixed information transmitted from the server group 311 in step S3 of FIG. 8 described above via the network 313 and the communication unit 22. The information acquisition unit 412 causes the storage unit 28 to store the fixed information.

Thereafter, the processing proceeds to step S55.

On the other hand, in a case where it is determined in step S52 that the fixed information is not receivable, the processing in steps S53 and S54 is skipped, and the processing proceeds to step S55.

Furthermore, in a case where it is determined in step S51 that acquisition of the fixed information has not been requested, the processing in steps S52 to S54 is skipped, and the processing proceeds to step S55.

In step S55, the information acquisition unit 412 of the vehicle 1 determines whether or not the notification of the start of the event has been made. In a case where it is determined that the notification of the start of the event has not been made, the processing returns to step S51.

Thereafter, the processing in steps S51 to S55 is repeatedly executed until it is determined in step S55 that the notification of the start of the event has been made.

On the other hand, in step S55, in a case where the event start notification signal transmitted from the server group 311 in step S5 of FIG. 8 described above is received via the network 313 and the communication unit 22, the information acquisition unit 412 of the vehicle 1 determines that the notification of the start of the event has been made, and the processing proceeds to step S56.

In step S56, the state detection unit 411 of the vehicle 1 determines whether or not the high-definition real-time information is receivable. Specifically, the state detection unit 411 detects the state of the vehicle 1 by processing similar to step S52 described above.

For example, in a case where it is estimated that the movement state of the vehicle 1 is a state in which a communication line with a predetermined speed or higher for content distribution can be stably secured, the state detection unit 411 determines that the high-definition real-time information is receivable.

For example, in a case where the movement state of the vehicle 1 is similar to a case where the fixed information is receivable, the state detection unit 411 determines that the high-definition real-time information is receivable.

Further, for example, in a case where the vehicle 1 is traveling and the amount of communication data necessary for driving automation is estimated to be small (smaller than a predetermined threshold), the state detection unit 411 determines that the high-definition real-time information is receivable. The state in which the amount of communication data necessary for driving automation is estimated to be small is, for example, a case where the vehicle 1 is traveling at a predetermined speed or more on a road for cars only (hereinafter, referred to as a car-only road). That is, there is no pedestrian around the vehicle 1 and there is no traffic jam.

Then, in a case where it is determined that the high-definition real-time information is receivable, the processing proceeds to step S57.

In step S57, the information acquisition unit 412 of the vehicle 1 requests the high-definition real-time information. Specifically, the information acquisition unit 412 receives the control information including the field-of-view information from the information processing terminal 312 via the communication unit 22. The information acquisition unit 412 generates the high-definition real-time information request signal including the control information. The information acquisition unit 412 transmits the high-definition real-time information request signal to the server group 311 via the communication unit 22 and the network 313.

In step S58, the information acquisition unit 412 of the vehicle 1 receives the high-definition real-time information. Specifically, the information acquisition unit 412 receives the high-definition real-time information transmitted from the server group 311 in step S9 of FIG. 9 described above via the network 313 and the communication unit 22.

In step S59, the information processing terminal 312 reproduces the content on the basis of the high-definition real-time information.

Specifically, the output control unit 414 of the vehicle 1 transmits the high-definition real-time information to the information processing terminal 312 via the communication unit 22. That is, the high-definition video information and the sound information corresponding to the high-definition video information are output to the information processing terminal 312.

On the other hand, the communication unit 456 of the information processing terminal 312 receives the high-definition real-time information from the vehicle 1. The display unit 452 displays a high-definition video of the content on the basis of the high-definition video information included in the high-definition real-time information. The sound output unit 453 outputs a sound on the basis of the sound information included in the high-definition real-time information.

In this way, in a case where the high-definition real-time information is receivable, a high-definition free-viewpoint video of the event is presented to the user in substantially real time on the basis of a video obtained by actually imaging the event. As a result, a content that has achieved 3R (remote, real, and real-time) is provided to the user, and a content rich in interactivity can be provided to the user. For example, a performer of the event can respond to a reaction of the user (for example, support or the like).

Furthermore, since transmission of the high-definition real-time information is performed after it is confirmed that the high-definition real-time information is receivable, an increase in motion-to-photon latency is suppressed.

Thereafter, the processing proceeds to step S67.

On the other hand, in a case where it is determined in step S56 that the high-definition real-time information is not receivable, the processing proceeds to step S60. For example, in a case where the vehicle 1 is traveling and the amount of communication data necessary for driving automation is estimated to be large (equal to or larger than the predetermined threshold), it is determined that the high-definition real-time information is not receivable. The state in which the amount of communication data necessary for driving automation is estimated to be large is, for example, a case where the vehicle 1 is traveling in a place other than a car-only road, or a case where the vehicle 1 is traveling at a speed lower than a predetermined speed. That is, for example, it is a state in which there is a possibility that a pedestrian exists around the vehicle 1 or a state in which there is a traffic jam.

In step S60, the information acquisition unit 412 of the vehicle 1 determines whether or not the fixed information has been acquired. Specifically, in a case where the fixed information acquired before the start of the event is stored in the storage unit 28, the information acquisition unit 412 determines that the fixed information has been acquired, and the processing proceeds to step S61.

In step S61, the information acquisition unit 412 of the vehicle 1 requests the variable information. Specifically, the information acquisition unit 412 generates the variable information request signal and transmits the variable information request signal to the server group 311 via the communication unit 22 and the network 313.

In step S62, the information acquisition unit 412 of the vehicle 1 receives the variable information. Specifically, the information acquisition unit 412 receives the variable information transmitted from the server group 311 in step S11 of FIG. 9 described above via the network 313 and the communication unit 22.

In step S63, the vehicle 1 and the information processing terminal 312 reproduce the content on the basis of the fixed information and the variable information.

Specifically, the video generation unit 413 of the vehicle 1 generates the three-dimensional event model representing each scene of the content (event) on the basis of the fixed information and the variable information. The video generation unit 413 receives the control information including the field-of-view information described above from the information processing terminal 312 via the communication unit 22. The video generation unit 413 cuts out a video including a range corresponding to the field-of-view range of the user as it is from the three-dimensional event model without reducing the resolution on the basis of the control information. The output control unit 414 transmits the generated video information and the sound information corresponding to the video information to the information processing terminal 312 via the communication unit 22. That is, the video information generated by the video generation unit 413 and the sound information corresponding to the video information are output to the information processing terminal 312.

On the other hand, the communication unit 456 of the information processing terminal 312 receives the video information and the sound information from the vehicle 1. The display unit 452 displays a video based on the video information. The sound output unit 453 outputs a sound based on the sound information.

As a result, even in a case where the movement state of the vehicle 1 is not a state in which the high-definition real-time information is receivable, in other words, even in a case where it is difficult to secure a high-speed and stable communication line between the server group 311 and the vehicle 1, a high-definition free-viewpoint video of the event is presented to the user in substantially real time.

Furthermore, only the variable information is transmitted from the server group 311 to the vehicle 1, and rendering processing (processing of generating the three-dimensional event model and processing of generating the video information from the three-dimensional event model) is executed in the vehicle 1 on the basis of the variable information and the fixed information. As a result, the amount of data transmitted between the server group 311 and the vehicle 1 is reduced, and a time for the rendering processing is shortened. As a result, the motion-to-photon latency is shortened.

On the other hand, the amount of the variable information is smaller than that of the high-definition real-time information. Therefore, the video presented to the user may be different from the actual event. For example, it is difficult to express the sweat, tears, and the like of a performer only with the fixed information and the variable information. In addition, interactivity of a content may be reduced as compared with a case where the high-definition real-time information is used.

Thereafter, the processing proceeds to step S67.

On the other hand, in a case where it is determined in step S60 that the fixed information has not been acquired, the processing proceeds to step S64.

In step S64, the information acquisition unit 412 of the vehicle 1 requests the small-size real-time information. Specifically, the information acquisition unit 412 generates the small-size real-time information request signal and transmits the small-size real-time information request signal to the server group 311 via the communication unit 22 and the network 313.

In step S65, the information acquisition unit 412 of the vehicle 1 receives the small-size real-time information. Specifically, the information acquisition unit 412 receives the small-size real-time information transmitted from the server group 311 in step S14 of FIG. 9 described above via the network 313 and the communication unit 22.

In step S63, the vehicle 1 and the information processing terminal 312 reproduce the content on the basis of the small-size real-time information.

Specifically, the output control unit 414 of the vehicle 1 transmits the small-size real-time information to the information processing terminal 312 via the communication unit 22. That is, the small-size video information and the sound information corresponding to the small-size video information are output to the information processing terminal 312.

On the other hand, the communication unit 456 of the information processing terminal 312 receives the small-size real-time information from the vehicle 1. The display unit 452 displays a video based on the small-size video information included in the small-size real-time information. The sound output unit 453 outputs a sound based on the sound information included in the small-size real-time information.

As a result, even in a case where the movement state of the vehicle 1 is not a state in which the high-definition real-time information is receivable, in other words, in a case where it is difficult to secure a high-speed and stable communication line between the server group 311 and the vehicle 1, and the fixed information is not acquired in advance, the content showing the event can be provided to the user in substantially real time although interactivity of the content and the quality of the video are deteriorated.

Thereafter, the processing proceeds to step S67.

In step S67, the information acquisition unit 412 of the vehicle 1 determines whether or not the notification of the end of the event has been made. In a case where it is determined that the notification of the end of the event has not been made, the processing returns to step S56.

Thereafter, the processing in steps S56 to S67 is repeatedly executed until it is determined in step S67 that the notification of the end of the event has been made.

On the other hand, in step S67, in a case where the event end notification signal transmitted from the server group 311 in step S17 of FIG. 9 described above is received via the network 313 and the communication unit 22, the information acquisition unit 412 of the vehicle 1 determines that the notification of the end of the event has been made, and the content reproduction processing ends.

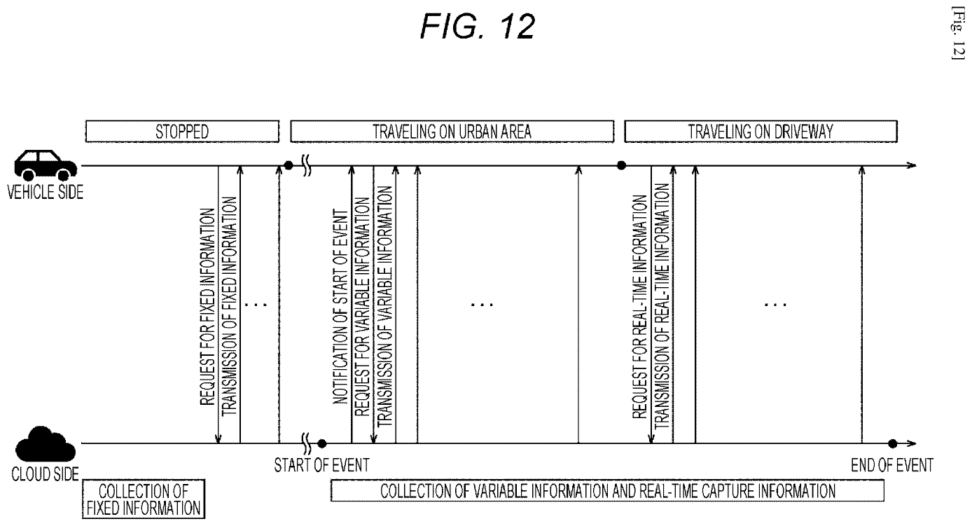

FIG. 12 illustrates an example of information transmitted between the cloud side (server group 311 side) and the vehicle 1 side in the above processing.

For example, first, the fixed information is collected on the cloud side. Then, while the vehicle 1 is stopped, the fixed information is transmitted from the cloud side to the vehicle 1 side in response to a request from the vehicle 1 side.

After the event is started, the variable information and the real-time capture information are collected on the cloud side until the event ends. In addition, the cloud side notifies the vehicle 1 side of the start of the event.

While the vehicle 1 is traveling in an urban area, the vehicle 1 requests the variable information to the cloud side and receives the variable information from the cloud side.

On the other hand, while the vehicle 1 is traveling on a car-only road, the vehicle 1 requests the (high-definition) real-time information to the cloud side and receives the (high-definition) real-time information from the cloud side.

Then, after the event ends, the cloud side notifies the vehicle 1 side of the end of the event.

As described above, a processing subject of the rendering processing and information transmitted between the server group 311 and the vehicle 1 are adaptively controlled according to the movement state of the vehicle 1, whereby deterioration in quality of a content viewed in the vehicle 1 is suppressed. For example, deterioration in video quality and an increase in motion-to-photon latency are suppressed.

Furthermore, a content rich in interactivity is provided to the user, and the user can have a more realistic feeling.

### 4. Second Embodiment

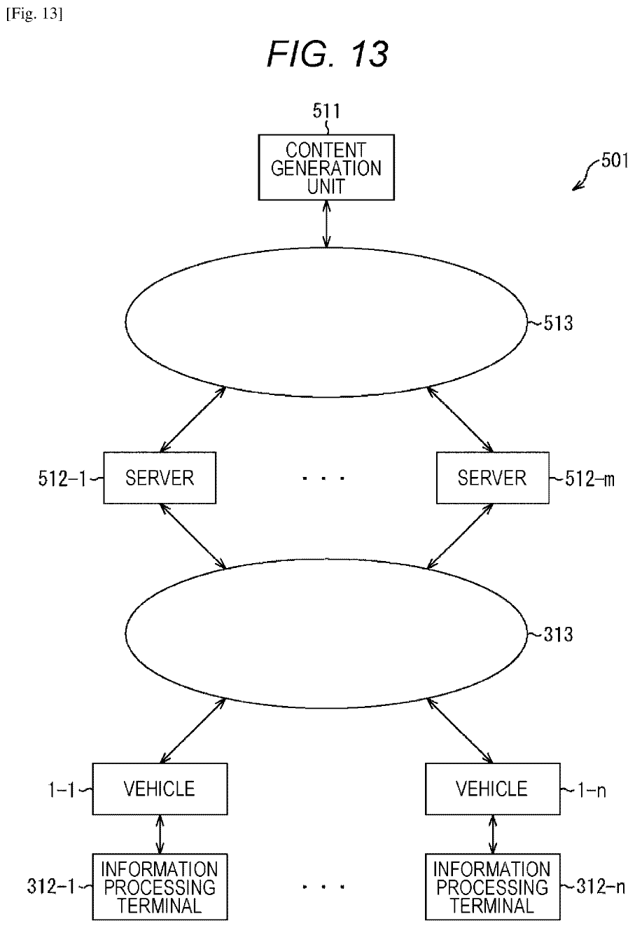

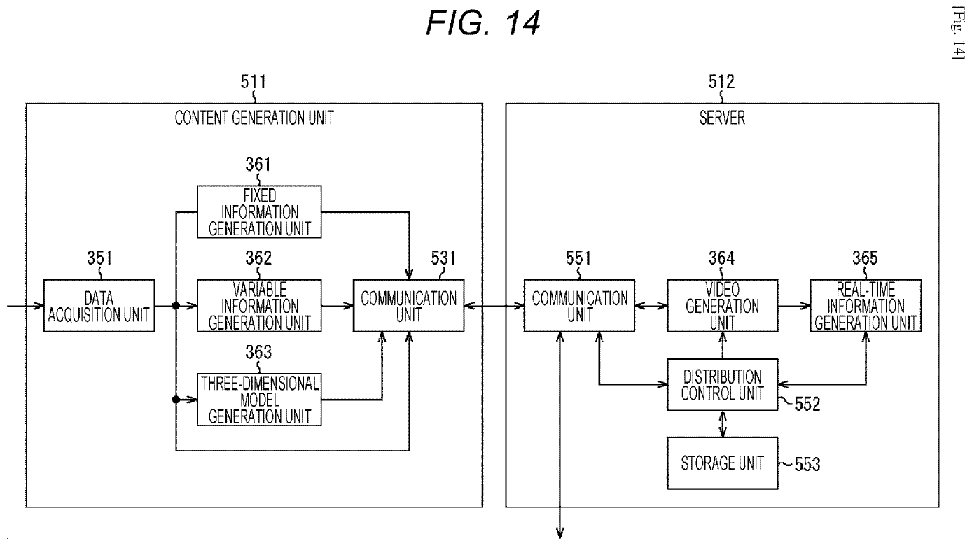

Next, a second embodiment of the present technology will be described with reference to FIGS. 13 and 14.

### Configuration Example of Information Processing System 501

FIG. 13 illustrates a configuration example of an information processing system 501 that is the second embodiment of the information processing system to which the present technology is applied. Note that, in FIG. 13, portions corresponding to those of the information processing system 301 in FIG. 5 are denoted by the same reference signs, and a description thereof will be omitted as appropriate.

The information processing system 501 is identical to the information processing system 301 in that the information processing system 501 includes vehicles 1-1 to 1-n, information processing terminals 312-1 to 312-n, and a network 313. On the other hand, the information processing system 501 is different from the information processing system 301 in that the information processing system 501 includes a content generation unit 511, servers 512-1 to 512-m, and a network 513, and does not include the server group 311.

The content generation unit 511 and the servers 512-1 to 512-m are connected to each other via the network 513. The servers 512-1 to 512-m and the vehicles 1-1 to 1-n are connected to each other via the network 313. Note that the network 313 and the network 513 are not necessarily separated, and all or some of them may be common.

Note that, hereinafter, in a case where it is not necessary to individually distinguish the servers 512-1 to 512-m, the servers 512-1 to 512-m are simply referred to as the server 512.

The content generation unit 511 and each server 512 share and execute the functions of the server group 311 in FIG. 6.

Specifically, the content generation unit 511 generates fixed information, variable information, a three-dimensional event model, sound information, and the like of a content, and transmits the information to each server 512 via the network 513.

Each server 512 generates high-definition real-time information or small-size real-time information on the basis of the three-dimensional event model and the sound information. Each server 512 transmits the fixed information, the variable information, the high-definition real-time information, or the small-size real-time information to each vehicle 1 via the network 313 in response to a request from each vehicle 1.

### Configuration Example of Content Generation Unit 511 and Server 512

FIG. 14 illustrates a functional configuration example of the content generation unit 511 and the server 512. Note that portions corresponding to those of the server group 311 in FIG. 6 are denoted by the same reference signs, and a description thereof will be omitted as appropriate. Furthermore, in FIG. 14, only one server 512 is illustrated, and illustration of the network 513 between the content generation unit 511 and the server 512 is omitted for easy understanding of the drawing.

The content generation unit 511 is identical to the server group 311 in that the content generation unit 511 includes a data acquisition unit 351, a fixed information generation unit 361, a variable information generation unit 362, and a three-dimensional model generation unit 363. On the other hand, the content generation unit 511 is different from the server group 311 in that the content generation unit 511 includes a communication unit 531 instead of the communication unit 354, and the content generation unit 511 does not include the distribution control unit 353, the video generation unit 364, and the real-time information generation unit 365.

The server 512 is identical to the server group 311 in that the server 512 includes a video generation unit 364 and a real-time information generation unit 365. On the other hand, the server 512 is different from the server group 311 in that the server 512 includes a distribution control unit 552 and a communication unit 551 instead of the distribution control unit 353 and the communication unit 354, includes a storage unit 553, and does not include the data acquisition unit 351, the fixed information generation unit 361, the variable information generation unit 362, and the three-dimensional model generation unit 363.

The communication unit 531 of the content generation unit 511 and the communication unit 551 of the server 512 communicate with each other via the network 513. Note that, as a communication scheme of the communication unit 531 and the communication unit 551, a high-speed and stable communication scheme is adopted so that a large-size entertainment content can be stably distributed.

The communication unit 531 of the content generation unit 511 transmits the fixed information, the variable information, the three-dimensional event model, and the sound information of the content to the server 512.

The communication unit 551 of the server 512 receives the fixed information, the variable information, the three-dimensional event model, and the sound information of the content from the content generation unit 511, and supplies the fixed information, the variable information, the three-dimensional event model, and the sound information to the distribution control unit 552.

The distribution control unit 552 causes the storage unit 553 to store the fixed information, the variable information, the three-dimensional event model, and the sound information as necessary. In a case where the fixed information or the variable information is requested from the vehicle 1, the distribution control unit 552 transmits the fixed information or the variable information to the vehicle 1 as the requester via the communication unit 551 and the network 313.

In a case where the high-definition real-time information is requested from the vehicle 1, the distribution control unit 552 supplies the three-dimensional event model and control information received from the vehicle 1 to the video generation unit 364, and supplies the sound information to the real-time information generation unit 365. The video generation unit 364 generates high-definition video information on the basis of the three-dimensional event model and the control information, and supplies the high-definition video information to the real-time information generation unit 365. The real-time information generation unit 365 generates the high-definition real-time information including the high-definition video information and the sound information, and supplies the high-definition real-time information to the distribution control unit 552. The distribution control unit 552 transmits the high-definition real-time information to the vehicle 1 as the requester via the communication unit 551 and the network 313.

In a case where the small-size real-time information is requested from the vehicle 1, the distribution control unit 552 supplies the three-dimensional event model to the video generation unit 364 and supplies the sound information to the real-time information generation unit 365. The video generation unit 364 generates small-size video information on the basis of the three-dimensional event model, and supplies the small-size video information to the real-time information generation unit 365. The real-time information generation unit 365 generates the small-size real-time information including the small-size video information and the sound information, and supplies the small-size real-time information to the distribution control unit 552. The distribution control unit 552 transmits the small-size real-time information to the vehicle 1 as the requester via the communication unit 551 and the network 313.

As described above, rendering processing related to generation of the high-definition real-time information and the small-size real-time information is executed by each server 512.

Here, the information acquisition unit 412 of each vehicle 1 preferentially requests the higher-definition real-time information from a closer server 512, for example, a server 512 closer to a wireless base station to which the communication unit 22 of each vehicle 1 is connected, and receives the higher-definition real-time information from the server 512. As a result, the motion-to-photon latency in a case where the content is reproduced on the basis of the high-definition real-time information is shortened.

Note that in a case where the vehicle 1 is traveling, as the wireless base station to which the communication unit 22 is connected is switched, the server 512 closest to the vehicle 1 is also switched. On the other hand, for example, the information acquisition unit 412 of the vehicle 1 may predict the next closest server 512 and reserve distribution of the high-definition real-time information to the predicted server 512. As a result, the high-definition real-time information is more smoothly distributed from each server 512 in accordance with the switching of the wireless base station to which the communication unit 22 is connected. As a result, the motion-to-photon latency is further shortened.

### 5. Modifications

Hereinafter, modifications of the above-described embodiments of the present technology will be described.

For example, in a case where the fixed information is not acquired in advance, the information acquisition unit 412 of the vehicle 1 may receive the fixed information from the server group 311 while reproducing the content on the basis of the small-size real-time information. Then, the information acquisition unit 412 may request the server group 311 for the high-definition real-time information according to the movement state of the vehicle 1 at a time point when reception of the fixed information is completed.

In the above description, an example has been described in which the information processing terminal 312 that includes the display unit 452 and reproduces a content is separated from the vehicle 1. However, for example, the present technology can also be applied to a case where a device (for example, a device included in the HMI 31) included in the vehicle 1 reproduces a content.

For example, the server group 311 may select and transmit information (for example, the high-definition real-time information, the small-size real-time information, or the variable information) to be transmitted to the vehicle 1 on the basis of the movement state of the vehicle 1 regardless of the request from the vehicle 1. In this case, for example, the vehicle 1 transmits a result of detecting the movement state, sensor data used for detecting the movement state, or the like to the server group 311.

The type of the event to which the present technology can be applied is not particularly limited.

The present technology can also be applied to a case where a content is distributed and reproduced by a streaming method other than a live streaming method. For example, the present technology can also be applied to a case where an on-demand content is distributed and reproduced by a streaming method.

The present technology can be applied not only to a vehicle but also to a moving body on which a user can board and view a content. For example, the present technology can also be applied to a train, a ship, and the like.

### 6. Others

### Configuration Example of Computer

The above-described series of processing can be executed by hardware or software. In a case where the series of processing is executed by software, a program as the software is installed in a computer. Here, the computer includes a computer incorporated in dedicated hardware, a general-purpose personal computer capable of executing various functions by installing various programs, and the like, for example.

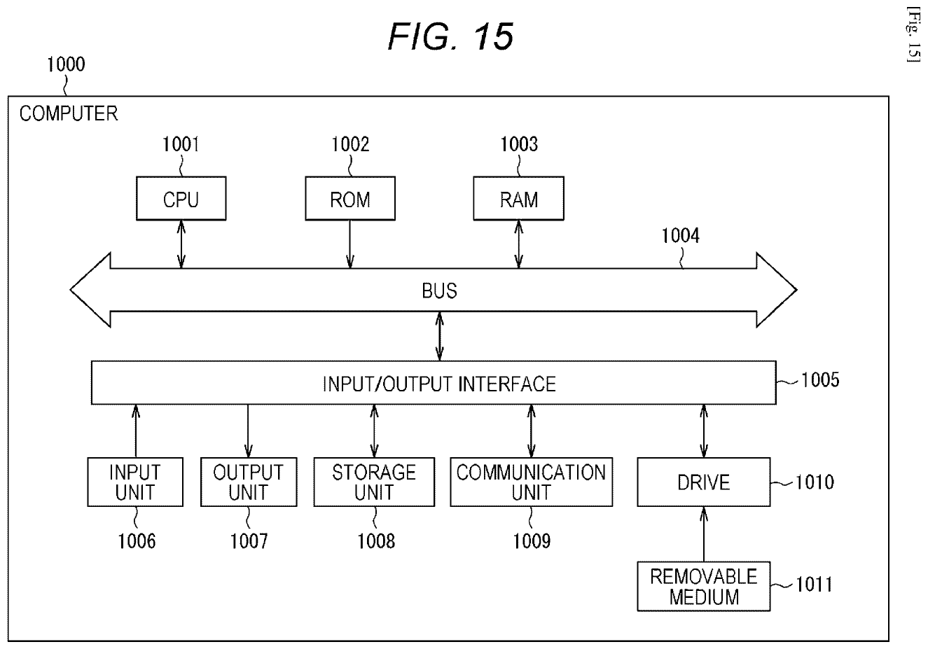

FIG. 15 is a block diagram illustrating a configuration example of hardware of a computer that executes the above-described series of processing by a program.

In a computer 1000, a central processing unit (CPU) 1001, a read only memory (ROM) 1002, and a random-access memory (RAM) 1003 are connected to one another via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The storage unit 1008 includes a hard disk, a non-volatile memory, and the like. The communication unit 1009 includes a network interface and the like. The drive 1010 drives a removable medium 1011 such as a magnetic disk, an optical disc, a magneto-optical disk, or a semiconductor memory.

In the computer 1000 configured as described above, for example, the CPU 1001 loads a program recorded in the storage unit 1008 into the RAM 1003 via the input/output interface 1005 and the bus 1004 and executes the program, whereby the above-described series of processing is executed.

The program executed by the computer 1000 (CPU 1001) can be provided by being recorded in the removable medium 1011 as a package medium or the like, for example. Furthermore, the program can be provided via a wired or wireless transmission medium such as a local area network, the Internet, or digital satellite broadcasting.

In the computer 1000, the program can be installed in the storage unit 1008 via the input/output interface 1005 by mounting the removable medium 1011 on the drive 1010. Furthermore, the program can be received by the communication unit 1009 via a wired or wireless transmission medium, and installed in the storage unit 1008. In addition, the program can be installed in the ROM 1002 or the storage unit 1008 in advance.

Note that the program executed by the computer may be a program for processing in time series in the order described in the present specification, or a program for processing in parallel or at a necessary timing such as when a call is made.

Furthermore, in the present specification, a system is intended to mean assembly of a plurality of components (devices, modules (parts), and the like) and it does not matter whether or not all the components are in the same housing. Therefore, a plurality of devices housed in separate housings and connected via a network and one device in which a plurality of modules is housed in one housing are both systems.

Moreover, the embodiments of the present technology are not limited to the above-described embodiments, and various modifications can be made without departing from the gist of the present technology.

For example, the present technology may be configured as cloud computing in which a function is shared by a plurality of devices through the network to process together.

Furthermore, each step described in the above described flowcharts may be performed by one device or by a plurality of devices in a shared manner.

Moreover, in a case where a plurality of processing is included in one step, the plurality of processing included in the one step can be executed by a single device or shared and executed by a plurality of devices.

Combination Example of Configurations The present technology can also have the following configurations.
1

An information processing device including:
an information acquisition unit that selects, on the basis of a movement state of a moving body, first video information indicating a video of a content viewed by a user in the moving body, or variable information that is information varying according to the content, and receives the selected first video information or variable information from a server group including one or more servers;
a video generation unit that generates second video information indicating a video of the content, on the basis of fixed information that is information fixed in the content and acquired in advance, and the variable information; and
an output control unit that controls output of the first video information and the second video information to a display unit.
   2

The information processing device according to (1), in which the movement state includes at least one of a place where the moving body is moving, a state around the moving body, or a state of the moving body.

3

The information processing device according to (2), in which the information acquisition unit receives the first video information from the server group in a case where the moving body is stopped or in a case where the moving body is moving in a predetermined place, and receives the variable information from the server group in a case where the moving body is moving in a place other than the predetermined place.

4

The information processing device according to (3), in which the information acquisition unit receives the fixed information from the server group before distribution of the content starts while the moving body is stopped.

5

The information processing device according to (3) or (4), in which the moving body includes a vehicle, and
the predetermined place includes a road for cars only.
   6

The information processing device according to (5), in which the information acquisition unit receives the first video information from the server group in a case where the vehicle is stopped or in a case where the vehicle is traveling at a predetermined speed or higher on the road for cars only, and receives the variable information from the server group in a case where the vehicle is traveling in a place other than the road for cars only or in a case where the vehicle is traveling at a speed lower than the predetermined speed.

7

The information processing device according to any one of (1) to (6), in which the output control unit outputs the first video information to the display unit in a case where the information acquisition unit has received the first video information, and outputs the second video information to the display unit in a case where the information acquisition unit has received the variable information.

8

The information processing device according to any one of (1) to (7), in which the content includes a free-viewpoint video of an event.

9

The information processing device according to (8), in which the information acquisition unit transmits control information including information regarding a field of view of the user to the server group, and receives, from the server group, the first video information generated from a first three-dimensional model representing each scene of the event on the basis of the control information.

10

The information processing device according to (9), in which the video generation unit generates, on the basis of the control information, the second video information from a second three-dimensional model based on the fixed information and the variable information, the second three-dimensional model representing each scene of the event.

11

The information processing device according to any one of (8) to (10), in which the fixed information includes at least one of information regarding a place where the event is held, information regarding an appearance of a performer of the event, information regarding planning of a production of the event, or information regarding an appearance of an audience of the event, and
the variable information includes at least one of information regarding a motion of the performer, information regarding a motion of the production, or information regarding a motion of the audience.
   12

The information processing device according to any one of (8) to (11), in which the display unit is configured to display the free-viewpoint video.

13

The information processing device according to (12), in which the display unit includes a head mounted display.

14

The information processing device according to any one of (1) to (13), in which the content is live-streamed.

15

The information processing device according to any one of (1) to (14), in which the first video information has a higher definition than that of the second video information.

16

The information processing device according to any one of (1) to (15), further including a state detection unit that detects the movement state.

17

The information processing device according to any one of (1) to (16), in which the display unit is provided outside.

18

The information processing device according to any one of (1) to (17), further including the display unit.

19

The information processing device according to any one of (1) to (18), in which the information acquisition unit preferentially receives the first video information from the server closer to the moving body in the server group.

20

An information processing method executed by an information processing device, the information processing method including:
selecting, on the basis of a movement state of a moving body, first video information indicating a video of a content viewed by a user in the moving body, or variable information that is information varying according to the content, and receiving the selected first video information or variable information from a server group including one or more servers;
outputting the first video information to a display unit in a case where the first video information is received; and
generating second video information indicating a video of the content on the basis of fixed information that is information fixed in the content and acquired in advance, and the variable information, and outputting the second video information to the display unit in a case where the variable information is received.

Note that the effects described herein are merely examples and are not limited, and other effects may be provided.

It should be understood by those skilled in the art that various modifications, combinations, sub-combinations and alterations may occur depending on design requirements and other factors insofar as they are within the scope of the appended claims or the equivalents thereof.

### Reference Signs List

1 Vehicle
301 Information processing system
311 Server group
312-1 to 312-n Information processing terminal
351 Data acquisition unit
352 Content information generation unit
353 Distribution control unit
354 Communication unit
361 Fixed information generation unit
362 Variable information generation unit
363 Three-dimensional model generation unit
364 Video generation unit
365 Real-time information generation unit
401 Information processing system
411 State detection unit
412 Information acquisition unit
413 Video generation unit
414 Output control unit
451 Control unit
452 Display unit
453 Sound output unit
454 Operation unit
455 Motion detection unit
456 Communication unit
501 Information processing system
511 Content generation unit
512-1 to 512-m Server
552 Distribution control unit

1. An information processing device comprising:
an information acquisition unit that selects, on a basis of a movement state of a moving body, first video information indicating a video of a content viewed by a user in the moving body, or variable information that is information varying according to the content, and receives the selected first video information or variable information from a server group including one or more servers;
a video generation unit that generates second video information indicating a video of the content, on a basis of fixed information that is information fixed in the content and acquired in advance, and the variable information; and
an output control unit that controls output of the first video information and the second video information to a display unit.

2. The information processing device according to claim 1, wherein the movement state includes at least one of a place where the moving body is moving, a state around the moving body, or a state of the moving body.

3. The information processing device according to claim 2, wherein the information acquisition unit receives the first video information from the server group in a case where the moving body is stopped or in a case where the moving body is moving in a predetermined place, and receives the variable information from the server group in a case where the moving body is moving in a place other than the predetermined place.

4. The information processing device according to claim 3, wherein the information acquisition unit receives the fixed information from the server group before distribution of the content starts while the moving body is stopped.

5. The information processing device according to claim 3, wherein the moving body includes a vehicle, and
the predetermined place includes a road for cars only.

6. The information processing device according to claim 5, wherein the information acquisition unit receives the first video information from the server group in a case where the vehicle is stopped or in a case where the vehicle is traveling at a predetermined speed or higher on the road for cars only, and receives the variable information from the server group in a case where the vehicle is traveling in a place other than the road for cars only or in a case where the vehicle is traveling at a speed lower than the predetermined speed.

7. The information processing device according to claim 1, wherein the output control unit outputs the first video information to the display unit in a case where the information acquisition unit has received the first video information, and outputs the second video information to the display unit in a case where the information acquisition unit has received the variable information.

8. The information processing device according to claim 1, wherein the content includes a free-viewpoint video of an event.

9. The information processing device according to claim 8, wherein the information acquisition unit transmits control information including information regarding a field of view of the user to the server group, and receives, from the server group, the first video information generated from a first three-dimensional model representing each scene of the event on a basis of the control information.

10. The information processing device according to claim 9, wherein the video generation unit generates, on a basis of the control information, the second video information from a second three-dimensional model based on the fixed information and the variable information, the second three-dimensional model representing each scene of the event.

11. The information processing device according to claim 8, wherein the fixed information includes at least one of information regarding a place where the event is held, information regarding an appearance of a performer of the event, information regarding planning of a production of the event, or information regarding an appearance of an audience of the event, and
the variable information includes at least one of information regarding a motion of the performer, information regarding a motion of the production, or information regarding a motion of the audience.

12. The information processing device according to claim 8, wherein the display unit is configured to display the free-viewpoint video.

13. The information processing device according to claim 12, wherein the display unit includes a head mounted display.

14. The information processing device according to claim 1, wherein the content is live-streamed.

15. The information processing device according to claim 1, wherein the first video information has a higher definition than that of the second video information.

16. The information processing device according to claim 1, further comprising a state detection unit that detects the movement state.

17. The information processing device according to claim 1, wherein the display unit is provided outside.

18. The information processing device according to claim 1, further comprising the display unit.

19. The information processing device according to claim 1, wherein the information acquisition unit preferentially receives the first video information from the server closer to the moving body in the server group.

20. An information processing method executed by an information processing device, the information processing method comprising:
selecting, on a basis of a movement state of a moving body, first video information indicating a video of a content viewed by a user in the moving body, or variable information that is information varying according to the content, and receiving the selected first video information or variable information from a server group including one or more servers;
outputting the first video information to a display unit in a case where the first video information is received; and
generating second video information indicating a video of the content on a basis of fixed information that is information fixed in the content and acquired in advance, and the variable information, and outputting the second video information to the display unit in a case where the variable information is received.
